(19) United States
(12) Patent Application Publication
(10) Pub. No.: US 2017/0206677 A1
(43) Pub. Date: Jul. 20, 2017

(54) Intelligent Color Palettes Based on One or More Principal Colors

(71) Applicant: ADP, LLC, Roseland, NJ (US)

(72) Inventor: Benjamin John Dziuba, New York, NY (US)

(21) Appl. No.: 14/995,683

(22) Filed: Jan. 14, 2016

(51) Int. Cl. G06T 11/00

(52) U.S. Cl. CPC G06T 11/001

(57) ABSTRACT

A palette generator generates a set of color palettes displaying a graphical user interface on a display system. The palette generator identifies a principal color and an accent color for. The palette generator then identifies a set of interactivity colors based on an application of a set of rules to at least one of the principal color and the accent color. The palette generator identifies a set of data visualization colors based on an application of a set of rules to at least one of the principal color, the accent color, and the set of interactivity colors. The palette generator then generates a set of color palettes from the principal color, the accent color, the set of interactivity colors, and the set of data visualization colors. The display system then displays the graphical user interface according to one of the set of color palettes.

### BACKGROUND INFORMATION

1. Field

The present disclosure relates generally to an improved computer system and, in particular, to a method and apparatus for generating color palettes for a graphical user interface in a computer system. Still more particularly, the present disclosure relates to a method and apparatus for intelligently generating color palettes based on one or more principal colors for a graphical user interface in a computer system.

2. Background

Information systems are used for many different purposes. For example, an information system may be used to process payroll to generate paychecks for employees in an organization. Additionally, an information system also may be used by a human resources department to maintain benefits and other records about employees. For example, a human resources department may manage health insurance, wellness plans, and other programs and organizations using an employee information system. As yet another example, an information system may be used to determine when to hire new employees, assign employees to projects, perform reviews for employees, and other suitable operations for the organization. As another example, a research department in the organization may use an information system to store and analyze information to research new products, perform reviews of employees, hire new employees, analyze products, or for other suitable operations.

Currently used information systems include databases. These databases store information about the organization. For example, these databases store information about employees, products, research, product analysis, business plans, and other information about the organization.

Information in databases can be accessed through a graphical user interface of a computer system. The information systems may be used in performing operations for an organization. The operations may include hiring operations and project assignments.

A graphical user interface allows users to perform operations for an organization by interacting with electronic devices through manipulation of graphical elements and visual indicators, such as icons. Manipulation of icons in a graphical user interface allows the user to more easily learn and use the computer system areas additionally, a user typically makes fewer errors and complete tasks in less time using a graphical user interface as opposed to text based interfaces that utilize typed commands and navigation.

Developing and designing a visual composition of a graphical user interface is important for the efficient performance of operations in an information system. Ideally, the visual composition of the graphical user interface enhances is to enhance the human-computer interaction by efficiently and easily presenting operations and information according to a logical and aesthetically harmonious design. As part of this harmonious design, the graphical user interface is often presented according to a selected color palette.

In computer graphics, a color palette is a finite set of colors are used to present digital images, such as the graphical elements and visual indicators of a graphical user interface. However, a randomly generated color palette may not result in a visually harmonious set of colors.

In creating a harmonious visual experience that enhances the human-computer interaction, harmony is something that is pleasing to the eye. Color harmony is the theory of combining colors that work well together in a fashion that is visually pleasing to the eye of the user. A color palette that presents a graphical user interface with harmonious colors enhance the human-computer interaction by efficiently and easily presenting operations and information according to a logical and aesthetically harmonious design.

However, the time and resources needed to generate a harmonious color palette may be greater than desired. For example, organizations typically have organizational images, including brand images, logos, and trademarks. These organizational images often utilize one or more colors chosen for effectively creating an association between the chosen colors and the organization. Generating a color palette including additional colors that are harmonious with the colors in an organizational image may require more time and resources than desired.

For example, the graphical user interface may be used to present information that is utilized in performing operations for the organization. The graphical user interface can present different information in a table or graph displayed within the interface in different harmonious colors. As the number of parameters or amounts of information increases, the complexity for generating additional harmonious colors for presenting the permission also increases. As a result, generating a color palette including additional colors that are harmonious with the colors in an organizational image may be greater than desired.

Therefore, it would be desirable to have a method and apparatus that take into account at least some of the issues discussed above, as well as other possible issues. For example, it would be desirable to have a method and apparatus that overcome a technical problem of generating visually harmonious for an organization based on an organizational image more efficiently than is currently used pallet generating systems.

### SUMMARY

An embodiment of the present disclosure provides a method for displaying a graphical user interface. A computer system identifies a principal color for a graphical user interface to be displayed on a display system. The computer system identifies an accent color for the graphical user interface. The computer system then identifies a set of interactivity colors for presenting system activities in graphical user interface. The set of interactivity colors are identified based on an application of a set of rules to at least one of the principal color and the accent color. The computer system identifies a set of data visualization colors for presenting data visualization in graphical user interface. The set of data visualization colors are identified based on an application of a set of rules to at least one of the principal color, the accent color, and the set of interactivity colors. The computer system then generates a set of color palettes from the principal color, the accent color, the set of interactivity colors, and the set of data visualization colors. The computer system then displays the graphical user interface according to one of the set of color palettes, enabling performing an operation for the organization based on information presented in the graphical user interface according to the selected one of the set of color palettes.

Another embodiment of the present disclosure provides a computer system comprising a display system and a palette generator in communication with the display system. A palette generator identifies a principal color for a graphical user interface to be displayed on a display system. The palette generator identifies an accent color for the graphical user interface. The palette generator then identifies a set of interactivity colors for presenting system activities in graphical user interface. The set of interactivity colors are identified based on an application of a set of rules to at least one of the principal color and the accent color. The palette generator identifies a set of data visualization colors for presenting data visualization in graphical user interface. The set of data visualization colors are identified based on an application of a set of rules to at least one of the principal color, the accent color, and the set of interactivity colors. The palette generator then generates a set of color palettes from the principal color, the accent color, the set of interactivity colors, and the set of data visualization colors. The display system then displays the graphical user interface according to one of the set of color palettes generated by the palette generator, enabling performing an operation for the organization based on information presented in the graphical user interface according to the selected one of the set of color palettes.

Yet another embodiment of the present disclosure provides computer program product for displaying a graphical user interface comprising a computer readable storage media, and first program code, second program code, third program code, fourth program code, fifth program code, and sixth program code stored on the computer readable storage media. The first program code identifies a principal color for a graphical user interface to be displayed on a display system. The second program code identifies an accent color for the graphical user interface. The third program code identifies a set of interactivity colors for presenting system activities in graphical user interface. The set of interactivity colors are identified based on an application of a set of rules to at least one of the principal color and the accent color. The fourth program code identifies a set of data visualization colors for presenting data visualization in graphical user interface. The set of data visualization colors are identified based on an application of a set of rules to at least one of the principal color, the accent color, and the set of interactivity colors. The fifth program code then generates a set of color palettes from the principal color, the accent color, the set of interactivity colors, and the set of data visualization colors. The sixth program code displays the graphical user interface according to one of the set of color palettes generated by the palette generator, enabling performing an operation for the organization based on information presented in the graphical user interface according to the selected one of the set of color palettes.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a palette generation environment in accordance with an illustrative embodiment;

FIG. 2 is an illustration of a block diagram of a data flow for identifying a principal color and an accent color to be included in a color palette for displaying a graphical user interface in accordance with an illustrative embodiment;

FIG. 3 is an illustration of a block diagram of a data flow for generating a color palette according to a number of color harmony rules in accordance with an illustrative embodiment;

FIG. 4 is an illustration of a block diagram of a data flow for generating a color palette according to a number of color harmony rules in accordance with an illustrative embodiment;

FIG. 5 is an illustration of a subtractive color model color wheel for identifying a harmonious colors in accordance with an illustrative embodiment;

FIG. 6 is an illustration of a complementary color harmony rule graphically displayed on a red-blue-yellow color wheel for identifying harmonious colors in accordance with an illustrative embodiment;

FIG. 7 is an illustration of an analogous color harmony rule graphically displayed on a red-blue-yellow color wheel for identifying harmonious colors in accordance with an illustrative embodiment;

FIG. 8 is an illustration of a triadic color harmony rule graphically displayed on a red-blue-yellow color wheel for identifying harmonious colors in accordance with an illustrative embodiment;

FIG. 9 is an illustration of a split-complementary color harmony rule graphically displayed on a red-blue-yellow color wheel for identifying harmonious colors in accordance with an illustrative embodiment;

FIG. 10 is an illustration of a tetratic color harmony rule graphically displayed on a red-blue-yellow color wheel for identifying harmonious colors in accordance with an illustrative embodiment;

FIG. 11 is an illustration of a square color harmony rule graphically displayed on a red-blue-yellow color wheel for identifying harmonious colors in accordance with an illustrative embodiment;

FIG. 12 is an illustration of a subtractive color model color wheel for identifying harmonious colors in accordance with an illustrative embodiment;

FIG. 13 is an illustration of a series of pixels arranged according to a first pixel pattern for displaying the generated color palette in accordance with an illustrative embodiment;

FIG. 14 is an illustration of a series of pixels arranged according to a second pixel pattern for displaying the generated color palette in accordance with an illustrative embodiment;

FIG. 15 is an illustration of a series of pixels arranged according to a third pixel pattern for displaying the generated color palette in accordance with an illustrative embodiment;

FIG. 16 is an illustration of a block diagram of a data flow for identifying a color palette according to a triadic color harmony rules in accordance with an illustrative embodiment;

FIG. 17 is an illustration of a block diagram of a data flow for identifying a color palette according to a tetratic color harmony rules in accordance with an illustrative embodiment;

FIG. 18 is an illustration of a flowchart of a process for generating a set of color palettes for displaying a graphical user interface in accordance with an illustrative embodiment;

FIG. 19 is an illustration of a flowchart of a process for generating a set of color palettes based on a relationship between a principal color and an accent color in accordance with an illustrative embodiment;

FIG. 20 is an illustration of a flowchart of a process for generating a set of color palettes by applying shading rules and tinting rules to a principal color and an accent color in accordance with an illustrative embodiment of all;

FIG. 21 is an illustration of a flowchart of a process for generating a set of color palettes by applying shading rules and tinting rules to a principal color and an accent color in accordance with an illustrative embodiment; and

FIG. 22 is an illustration of a block diagram of a data processing system in accordance with an illustrative embodiment.

### DETAILED DESCRIPTION

The illustrative embodiments recognize and take into account one or more different considerations. For example, the illustrative embodiments recognize and take into account that one manner in which presenting information in a graphical user interface may be performed more efficiently is to use separate colors for visualizing different data sets. The illustrative embodiments also recognize and take into account that improvements may be made to the manner in which a harmonious color for presenting different data sets is generated.

Those embodiments recognize and take into account that some organizations may desire to present data sets according to a harmonious color palette that is based on an organizational image. However, those organizations may have a desire to more efficiently generate a harmonious color palette for presenting information and data sets within a graphical user interface. In particular, an organization may wish to efficiently generate a color palette that displays a dataset based on organizational image to enhance the human-computer interaction. Those embodiments recognize and take into account that generating harmonious color palettes consistent with an organizational image is desirable such that operations can be performed and information can be accessed more efficiently and easily according to a logical and aesthetically harmonious design.

Thus, the illustrative embodiments provide a method and apparatus for displaying a graphical user interface. The process, in one illustrative example, identifies a principal color for a graphical user interface to be displayed on a display system. The process identifies an accent color for the graphical user interface. The process identifies a set of interactivity colors for presenting system activities in graphical user interface. The set of interactivity colors are identified based on an application of a set of rules to at least one of the principal color and the accent color. The process identifies a set of data visualization colors for presenting data visualization in graphical user interface. The set of data visualization colors are identified based on an application of a set of rules to at least one of the principal color, the accent color, and the set of interactivity colors. The process generates a set of color palettes from the principal color, the accent color, the set of interactivity colors, and the set of data visualization colors. The process displays the graphical user interface according to one of the set of color palettes, enabling performing an operation for the organization based on information presented in the graphical user interface according to the selected one of the set of color palettes.

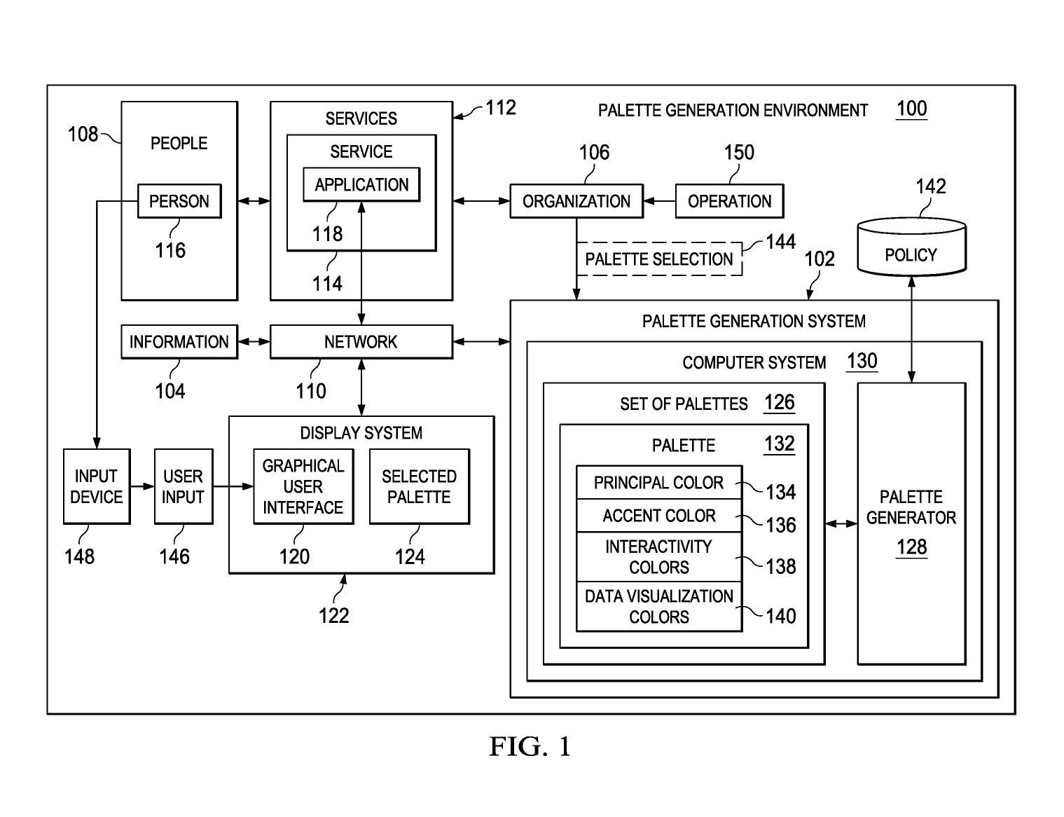

With reference now to the figures and, in particular, reference to FIG. 1, an illustration of a block diagram of a palette generation environment is depicted in accordance with an illustrative embodiment. In this illustrative example, palette generation environment 100 includes palette generation system 102. Palette generation system 102 provides access to information 104. The access of information 104 may be at least one of reading, writing, modifying, storing, or deleting information 104.

Information 104 may be information about organization 106. Information 104 may be information for at least one of people, products, services, business plans, performance reviews, payroll, human resources, benefits administration, business plans, marketing, research, product development, or other suitable information.

As used herein, the phrase “at least one of,” when used with a list of items, means different combinations of one or more of the listed items may be used and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In the illustrative example, organization 106 may be, for example, a corporation, a partnership, a charitable organization, a city, a government agency, or some other suitable type of organization. People 108 may be employees of organization 106. In other illustrative examples, people 108 may be members of organization 106 without being employees.

People 108 access information 104 across network 110 by service 114 of services 112. In one illustrative example, person 116 uses service 114 to access at least one of payroll information, benefits administration information, product development information, marketing information, or other suitable information in information 104.

Network 110 is located in at least one of palette generation system 102 or outside of palette generation system 102. For example, network 110 may include at least one of a local area network (LAN), a wide area network (WAN), the Internet, an intranet, or some other suitable type of network.

In one illustrative example, organization 106 provides service 114 to person 116 through application 118. Application 118 is a software program that implements service 114 for person 116. Person 116 interacts with application 118 through graphical user interface 120 displayed on display system 122.

Graphical user interface 120 is displayed on display system 122 and provides visualization of information 104 and interaction with services 114 through application 118. In this illustrative example, graphical user interface 120 is displayed on display system 122 according to a selected palette 124.

As depicted, display system 122 is a hardware system and includes one or more display devices on which graphical user interface 120 may be displayed. The display devices may include at least one of a light emitting diode display (LED), a liquid crystal display (LCD), an organic light emitting diode display (OLED), or some other suitable device on which graphical user interface 120 can be displayed. Person 116 may interact with graphical user interface 120 through user input 146 generated by input device 148. Input device 148 may be, for example, a mouse, a keyboard, a trackball, a touchscreen, a stylus, or some other suitable type of input device.

Selected palette 124 is a color palette that includes a set of colors used to present graphical user interface 120, as well as information 104 displayed therein, on display system 122. Is in one illustrative example, selected palette 124 is selected from set of palettes 126 generated by palette generator 128.

In one illustrative example, palette generator 128 may be used to generate set of palettes 126 for displaying graphical user interface 120 on display system 122. As depicted, palette generator 128 may be implemented in software, hardware, firmware or a combination thereof. When software is used, the operations performed by palette generator 128 may be implemented in program code configured to run on hardware, such as a processor unit. When firmware is used, the operations performed by palette generator 128 may be implemented in program code and data and stored in persistent memory to run on a processor unit. When hardware is employed, the hardware may include circuits that operate to perform the operations in palette generator 128.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

As depicted, palette generator 128 may be implemented in computer system 130. Computer system 130 is a hardware system that includes one or more data processing systems. When more than one data processing system is present, those data processing systems may be in communication with each other using a communications medium. The communications medium may be a network, such as network 110. The data processing systems may be selected from at least one of a computer, a server computer, a tablet, or some other suitable data processing system.

In the illustrative example, person 116 may interact with application 118 through graphical user interface 120 displayed on display system 122 to access information 104. Graphical user interface 120 and information 104 are displayed on display system 122 according to selected palette 124. In the illustrative example, selected palette 124 presents information 104 within a graphical user interface 120 in a harmonious color palettes consistent with an organizational image is desirable such that information 104 can be efficiently and easily utilized in performing operations 150.

In operation, palette generator 128 in computer system 130 provides a method for generating set of palettes 126 for harmoniously displaying graphical user interface 120, as well as information 104 therein, on display system 122. In one illustrative example, palette generator 128 generates palette 132 of set of palettes 126 to include a plurality of colors. As depicted, palette 132 includes principal color 134, accent color 136, interactivity colors 138, and data visualization colors 140. In one illustrative example, palette generator 128 identifies one or more of principal color 134, accent color 136, interactivity colors 138, and data visualization colors 140 for inclusion in palette 132 based on an application policy 142.

Palette generator 128 identifies one or more of principal color 134, accent color 136, interactivity colors 138, and data visualization colors 140 for inclusion in palette 132 when a color meets policy 142. When palette 132 is generated from colors that meet policy 142, information 104 is displayed in graphical user interface 120 according to a logical and aesthetically harmonious design, and may be relied upon to perform operations 150 for organization 106 more efficiently and easily in this illustrative example.

As depicted, principal color 134 of palette 132 may be identified by searching network 110 for information 104. In other illustrative examples, principal color 134 may be identified in other ways. For example, principal color 134 may be found in other locations or in other manners other than searching network 110. In one illustrative example, principal color 134 may be specified by organization 106. In one illustrative example, principal color 134 may be identified from and organizational image. In one illustrative example, principal color 134 may be identified based on characteristics or traits that organization 106 desires to project about itself.

In this illustrative example, policy 142 is a group of rules. Policy 142 also may include data used to apply the group of rules. As used herein, the “group of,” when used with reference to items, means one or more items. For example, a “group of rules” is one or more rules.

As depicted, palette generator 128 identifies one or more of principal color 134, accent color 136, interactivity colors 138, and data visualization colors 140 for inclusion in palette 132 when policy 142 indicates that the selected colors are likely to create a harmonious visual experience when displayed in graphical user interface 120. Principal color 134, accent color 136, interactivity colors 138, and data visualization colors 140 are considered to create a harmonious visual experience when the selected colors correspond to one or more of a set of color harmony relationships. In one illustrative example, the set of color harmonies specify fixed relationships between two or more colors based on their relative positions in a color wheel. Palette 132 is considered to create a harmonious visual experience when the relationship between principal color 134, accent color 136, interactivity colors 138, and data visualization colors 140 meets policy 142.

As depicted, computer system 130 present set of palettes 126 to organization 106. Organization 106 makes palette selection 144. Palette selection 144 specifies one of set of palettes 126, such as palette 132, as selected palette 124. Based on palette selection 144, application 118 causes graphical user interface 120 and information 104 to be displayed in display system 122 according to selected palette 124.

As a result, information 104 is displayed in graphical user interface 120 according to a logical and aesthetically harmonious design, and may be relied upon to perform operations 150 for organization 106 more efficiently and easily based on an identification of set of palettes 126 using palette generator 128. In other words, a group of colors are be grouped together in a single harmonious palette 132 only if relationship between principal color 134, accent color 136, interactivity colors 138, and data visualization colors 140 meets one or more rules in policy 142. In this manner, performing operation 150 for organization 106 is more efficiently and easily enabled based on generating selected palette 124 for graphical user interface 120, and information 104 therein, displayed on display system 122.

The illustrative example in FIG. 1 and the examples in the other subsequent figures provide one or more technical solutions to overcome a technical problem of developing and designing a visual composition of a graphical user interface that is consistent with an organizational image that make for the efficient performance of operations in an information system more cumbersome and time-consuming than desired. For example, palette generator 128 adds palette 132 to set of palettes 126 when a relationship between principal color 134, accent color 136, interactivity colors 138, and data visualization colors 140 meets one or more rules in policy 142.

In this manner, the use of palette generator 128 has a technical effect of reducing time, effort, or both in identifying palette 132 for harmoniously displaying graphical user interface 120, and information 104 therein, on display system 122. In this manner, operation 150 performed for organization 106 may be performed more efficiently as compared to currently used systems. For example, selected palette 124 may be used to display information 104, enabling more efficient performance of operation 150, selected from at least one of hiring, benefits administration, payroll, performance reviews, forming teams for new products, assigning research projects, or other suitable operations for organization 106.

As a result, computer system 130 operates as a special purpose computer system in which palette generator 128 in computer system 130 enables generating set of palettes 126 for the display of graphical user interface 120, and information 104 therein, on display system 122. For example, palette generator 128 enables generating set of palettes 132 when a relationship between principal color 134, accent color 136, interactivity colors 138, and data visualization colors 140 meets one or more rules in policy 142. For example, a group of colors are be grouped together in a single harmonious palette 132 only if relationship between principal color 134, accent color 136, interactivity colors 138, and data visualization colors 140 meets one or more rules in policy 142.

Thus, palette generator 128 transforms computer system 130 into a special purpose computer system as compared to currently available general computer systems that do not have palette generator 128. Currently used general computer systems do not reduce the time or effort needed to develop and design a visual composition of a graphical user interface that is consistent with an organizational image. Further, currently used general computer systems do not provide generating set of palettes 132 based on a relationship between principal color 134, accent color 136, interactivity colors 138, and data visualization colors 140 that meets one or more rules in policy 142.

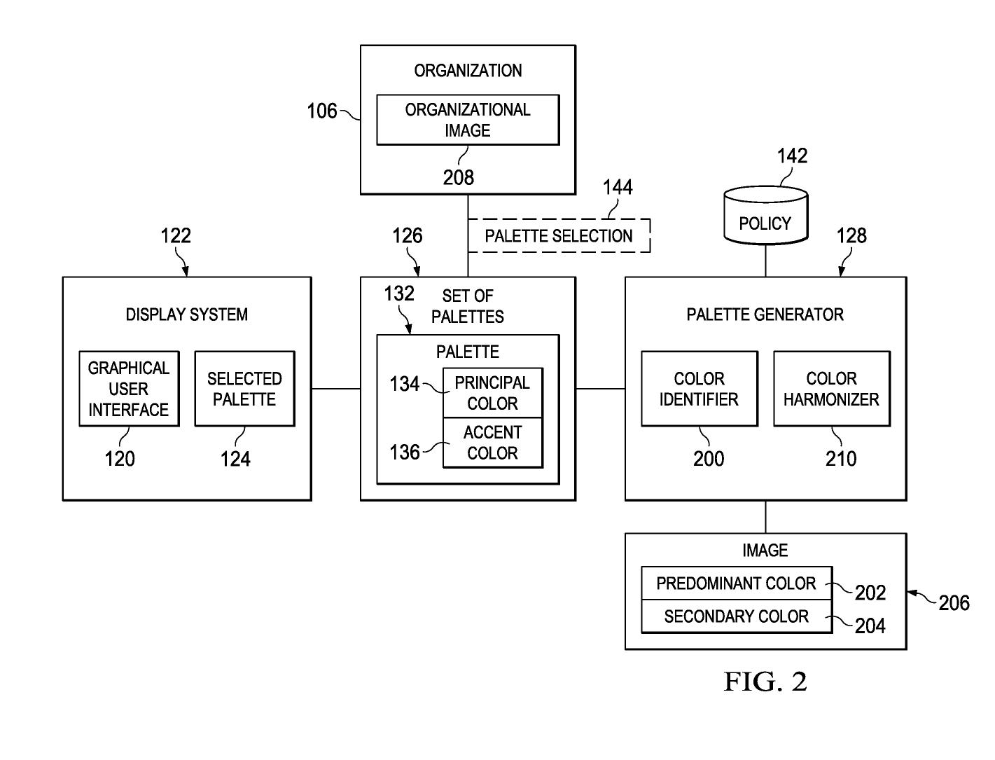

With reference next to FIG. 2, an illustration of a block diagram of a data flow for identifying a principal color and an accent color to be included in a color palette for displaying a graphical user interface is depicted in accordance with an illustrative embodiment. In this figure, an example of data flow for identifying principal color 134 and accent color 136 for palette 132 that meet policy 142 through palette generator 128 is shown. In the illustrative examples, the same reference numeral may be used in more than one figure. This reuse of a reference numeral in different figures represents the same element in the different figures.

As depicted, palette generator 128 has a number of different components. As used herein, a “number of items” means one or more items. For example, “a number of different components” means one or more components.

Palette generator 128 includes color identifier 200. Color identifier 200 in palette generator 128 identifies at least one of predominant color 202 and secondary color 204 from an image 206. In one illustrative example, color identifier 200 searches network 110 to locate image 206. In this illustrative example, color identifier 200 includes the functionality of at least one of a web crawler, a web browser, an email analyzer, or other suitable types of tools to search for image 206 in network 110.

In this illustrative example, image 206 is a digital image. Color identifier 200 identifies at least one of predominant color 202 and secondary color 204 from a three-byte hexadecimal number used to represent colors the red, green and blue components of colors in a digital image. Each byte represents a number in the range 00 to FF (in hexadecimal notation), representing the intensity of each color component. The three-byte hexadecimal color representation is formed by concatenating three bytes in hexadecimal notation, in the following order:
Byte 1: red intensity value
Byte 2: green intensity value
Byte 3: blue intensity value

In one illustrative example, color identifier 200 identifies at least one of predominant color 202 and secondary color 204 in image 206 from a physical image. In this illustrative example, color identifier 200 includes the functionality of at least one of an optical scanner, or other suitable types of tools to identify predominant color 202 and secondary color 204 from a physical image.

In one illustrative example, image 206 can be organizational image 208 of organization 106. Organizational image 208 is selected from at least one of brand images, logos, and trademarks. Organizational image 208 utilizes predominant color 202 and secondary color 204 chosen for effectively creating an association between the chosen colors and the organization 106.

As depicted, color identifier 200 identifies at least one of predominant color 202 and secondary color 204 in image 206. Predominant color 202 is a color that appears most frequently within image 206. Secondary color 204 is a color that is not as prevalent as predominant color 202, but appears more often than other colors in image 206. In one illustrative embodiment, secondary color 204 is a color appearing within image 206 with a second most prevalence.

Color harmonizer 210 applies a group of rules in policy 142 to image 206. Color harmonizer 210 determines at least one of principal color 134 and accent color 136 based on the results of applying the group of rules to image 206.

For example, one rule in policy 142 may determine principal color 134 from image 206. In this example, color harmonizer 210 identifies predominant color 202 as identified by color identifier 200. In this example, color harmonizer 210 applies a rules in policy 142 that sets principal color 134 equal to predominant color 202 identified within image 206 by color identifier 200.

Another rule in policy 142 may determine accent color 136 from image 206. In this example, color harmonizer 210 identifies secondary color 204 as identified by color identifier 200. In this example, color harmonizer 210 applies a rules in policy 142 that sets accent color 136 equal to secondary color 204 identified within image 206 by color identifier 200.

Another rule in policy 142 may determine accent color 136 by applying at least one of set of color harmonies that specify fixed relationships between two or more colors based on their relative positions in a color wheel. In this example, color harmonizer 210 identifies principal color 134 from palette 132. In this example, color harmonizer 210 applies at least one of set of color harmonies to principal color 134 to identify colors that have a specified relationship to principal color 134 based on their relative positions in a color wheel. Accent color 136 equal to secondary color 204 identified within image 206 by color identifier 200. In this example, color harmonizer 210 applies a rule in policy 142 that sets accent color 136 as a color identified according to the specified relationship to principal color 134.

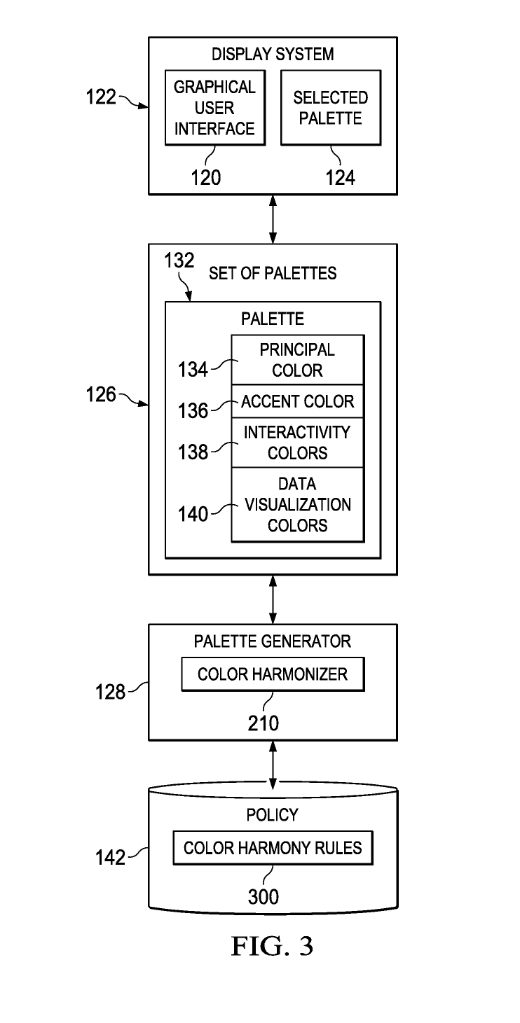

With reference now to FIG. 3, an illustration of a block diagram of a data flow for generating a color palette according to a number of color harmony rules is depicted in accordance with an illustrative embodiment. In this figure, an example of data flow for identifying interactivity colors 138 and data visualization colors 140 for palette 132 that meet policy 142 through palette generator 128 is shown.

Palette generator 128 determines interactivity colors 138 and data visualization colors 140 in palette 132. As depicted, Color harmonizer 210 applies one or more of a group of rules in policy 142 to determine interactivity colors 138 and data visualization colors 140. In this illustrative example, color harmonizer 210 determined interactivity colors 138 and data visualization colors 140 by applying color harmony rules 300 to at least one of principal color 134 and accent colors 136.

For example, one rule in policy 142 may determine interactivity colors 138 from principal color 134. In this example, color harmonizer identifies principal color 134 in palette 132. In this example, color harmonizer 210 applies color harmony rules 300 that specify a set of fixed relationships with principal color 134 to determine interactivity colors 138. The set of fixed relationships can determine interactivity colors 138 as one or more positions in a color wheel relative to principal color 134. In this illustrative example, palette generator 128 interactivity colors 138 equal to colors identified by color harmonizer 210 that meet color harmony rules 300 of policy 142.

In another illustrative example, one rule in policy 142 may determine interactivity colors 138 from accent color 136. In this example, color harmonizer identifies accent color 136 in palette 132. In this example, color harmonizer 210 applies color harmony rules 300 that specify a set of fixed relationships with accent color 136 to determine interactivity colors 138. The set of fixed relationships can determine interactivity colors 138 as one or more positions in a color wheel relative to accent color 136. In this illustrative example, palette generator 128 set interactivity colors 138 equal to colors identified by color harmonizer 210 that meet color harmony rules 300 of policy 142.

In yet another illustrative example, one rule in policy 142 may determine data visualization colors 140 from principal color 134. In this example, color harmonizer identifies principal color 134 in palette 132. In this example, color harmonizer 210 applies color harmony rules 300 that specify a set of fixed relationships with principal color 134 to determine data visualization colors 140. The set of fixed relationships can determine data visualization colors 140 as one or more positions in a color wheel relative to principal color 134. In this illustrative example, palette generator 128 data visualization colors 140 equal to colors identified by color harmonizer 210 that meet color harmony rules 300 of policy 142.

In yet another illustrative example, one rule in policy 142 may determine data visualization colors 140 from accent color 136. In this example, color harmonizer identifies accent color 136 in palette 132. In this example, color harmonizer 210 applies color harmony rules 300 that specify a set of fixed relationships with accent color 136 to determine data visualization colors 140. The set of fixed relationships can determine data visualization colors 140 as one or more positions in a color wheel relative to accent color 136. In this illustrative example, palette generator 128 set data visualization colors 140 equal to colors identified by color harmonizer 210 that meet color harmony rules 300 of policy 142.

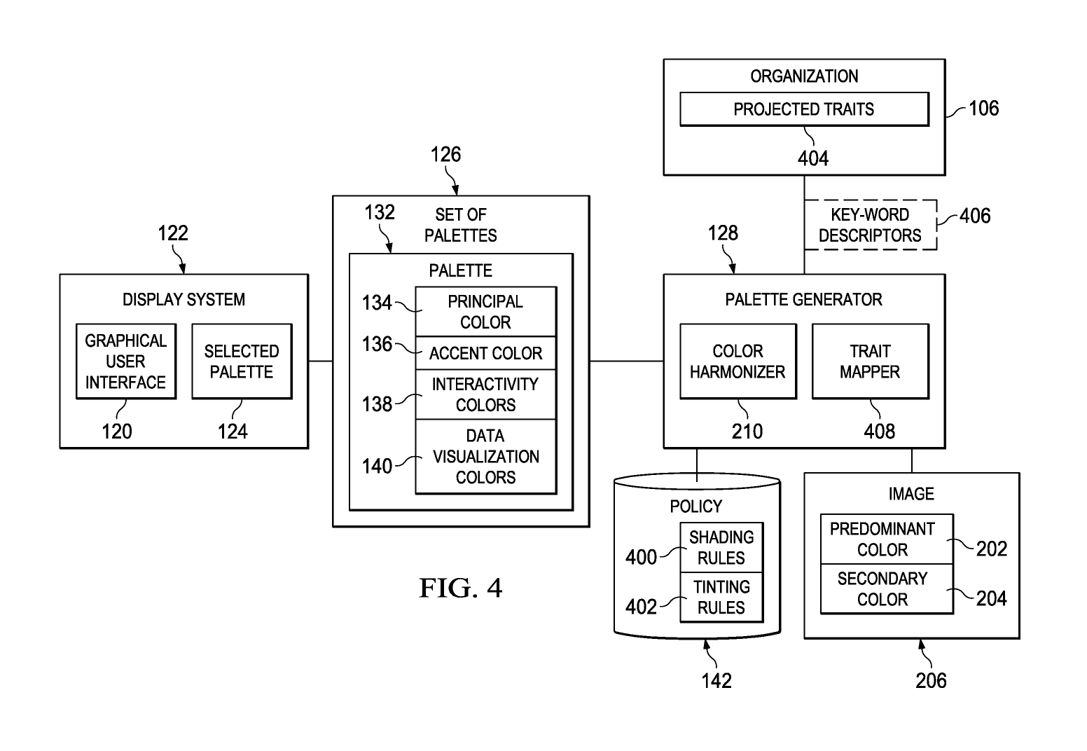

With reference now to FIG. 4, an illustration of a block diagram of a data flow for generating a color palette according to a number of color harmony rules is depicted in accordance with an illustrative embodiment. In this figure, an example of data flow for identifying interactivity colors 138 and data visualization colors 140 for palette 132 that meet policy 142 through palette generator 128 is shown.

Palette generator 128 determines interactivity colors 138 and data visualization colors 140 in palette 132. As depicted, color harmonizer 210 applies one or more of a group of rules in policy 142 to determine interactivity colors 138 and data visualization colors 140. In this illustrative example, color harmonizer 210 determines interactivity colors 138 and data visualization colors 140 by applying at least one of shading rules 400 and tinting rules 402 to at least one of principal color 134, accent colors 136, interactivity colors 138, and data visualization colors 140.

For example, one rule in policy 142 may determine at least one of interactivity colors 138 and data visualization colors 140 from at least one of principal color 134 and accent color 136. In this example, color harmonizer 210 identifies at least one of principal color 134 and accent color 136 in palette 132. In this example, color harmonizer 210 applies at least one of shading rules 400 and tinting rules 402 to at least one of principal color 134 and accent color 136. In this illustrative example, shading rules 400 are one or more rules within policy 142 that darken at least one of principal color 134 and accent color 136 without changing the color's hue. Similarly, tinting rules 402 are one or more rules within policy 142 that lighten at least one of principal color 134 and accent color 136 without changing the color's hue. In this illustrative example, palette generator 128 can set at least one of interactivity colors 138 and data visualization colors 140 equal to at least one shade of at least one of principal color 134 and accent color 136 based on the application of shading rules 400. Furthermore, palette generator 128 can set one or more of interactivity colors 138 equal to at least one tint of at least one of principal color 134 and accent color 136 based on the application of tinting rules 402.

In another illustrative example, one rule in policy 142 may determine additional interactivity colors 138 and additional data visualization colors 140 from interactivity colors 138 and data visualization colors 140. In this example, color harmonizer identifies at least one of interactivity colors 138 and data visualization colors 140 in palette 132. In this example, color harmonizer 210 applies at least one of shading rules 400 and tinting rules 402 to at least one of interactivity colors 138 and data visualization colors 140. In this illustrative example, shading rules 400 are one or more rules within policy 142 that darken at least one of interactivity colors 138 and data visualization colors 140 without changing the color's hue. Similarly, tinting rules 402 are one or more rules within policy 142 that lighten at least one of interactivity colors 138 and data visualization colors 140 without changing the color's hue. In this illustrative example, palette generator 128 can set additional ones of interactivity colors 138 and data visualization colors 140 equal to at least one shade of at least one of interactivity colors 138 and data visualization colors 140 based on the application of shading rules 400. Furthermore, palette generator 128 can set additional ones of interactivity colors 138 and data visualization colors 140 equal to at least one tint of at least one of interactivity colors 138 and data visualization colors 140 based on the application of tinting rules 402.

As depicted, organization 106 includes projected traits 404. Projected traits 404 are characteristics describing at least one of organization 106 and services 112 that organization 106 wishes to convey to people 108, depicted in block form in FIG. 1. In this illustrative example, organization 106 submits keyword descriptors 406 into palette generator 128, describing projected traits 404.

In this illustrative example, palette generator 128 includes trait mapper 408. Trait mapper 408 correlates keyword descriptors 406 to one or more of shading rules 400 and tinting rules 402. In this illustrative example, shading rules 400 and tinting rules 402 are rules designed to generate at least one of shades and tints that are intended to convey projected traits 404.

In an illustrative example, organization 106 provide services 112 targeting a first particular demographic within people 108, both shown in block form in FIG. 1. In this illustrative example, Keyword descriptors 406 entered into palette generator 128 are correlated by trait mapper 408 to particular rules of at least one of tinting rules 402 and shading rules 400. Color harmonizer 210 then applies tinting rules 402 identified by trait mapper 408 to determine at least one of interactivity colors 138 and data visualization colors 140.

In yet another illustrative example, organization 106 provides services 112 highlighted by a particular one of projected traits 404 of organization 106. In this illustrative example, keyword descriptors 406 entered into palette generator 128 are correlated by trait mapper 408 to particular rules of at least one of tinting rules 402 and shading rules 400. Color harmonizer 210 then applies at least one of tinting rules 402 and shading rules 400 identified by trait mapper 408 to determine at least one of interactivity colors 138 and data visualization colors 140.

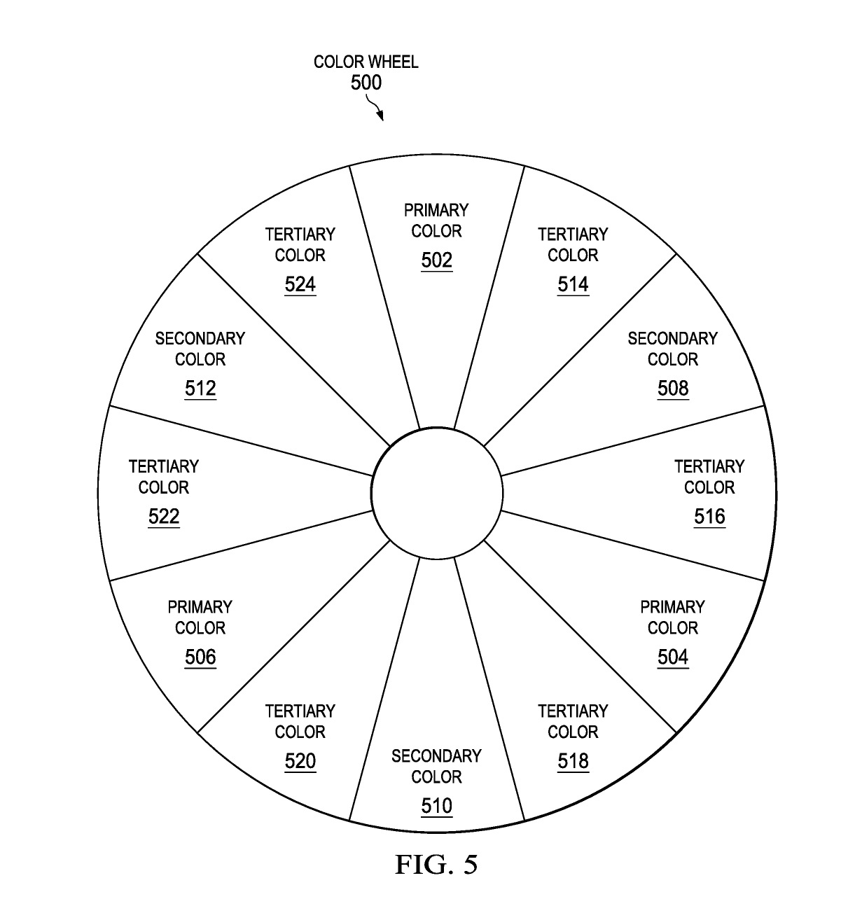

With reference next to FIG. 5, an illustration of a subtractive color model color wheel for identifying harmonious colors is depicted in accordance with an illustrative embodiment. In this figure, color wheel 500 is as an example of red-blue-yellow subtractive color model color wheel for identifying harmonious colors according to policy, such as policy 142 of FIG. 1.

Subtractive color models create different colors by mixing colors of pigment, such as paint or ink. Subtractive color processes work by blocking out parts of the visible light spectrum, reducing the amount of undesired color reaching the eye. Subtractive color models typically use familiar colors like red, yellow, and blue.

Color wheel 500 includes primary colors 502, 504, and 506. Primary colors are sets of colors that can be combined to make a useful range of colors. Human color vision is usually trichromatic. Therefore, three primary colors are typically used. Color wheel 500 uses a red-blue-yellow subtractive color model. In this illustrative example, color wheel 500 includes primary colors 502, 504, and 506 corresponding to the colors red, blue, and yellow.

Color wheel 500 includes secondary colors 508, 510, and 512. Secondary colors are sets of colors that made by combining equal amounts of two different primary colors. In this illustrative example, a secondary color 508 is made by combining primary color 502 in primary color 504; secondary color 510 is made by combining primary color 504 and primary color 506; a secondary color 512 is made by combining the primary color 506 and primary color 502. Color wheel 500 uses a red-blue-yellow subtractive color model. Therefore, color wheel 500 includes secondary colors 508, 510, and 512 corresponding to the colors orange, green, and purple.

Color wheel 500 includes tertiary colors 514, 516, 518, 520, 522, and 524. Tertiary colors are sets of colors that are made by combining different amounts of two different primary colors. In this illustrative example, tertiary color 514 is made by combining primary color 502 with secondary color 508; tertiary color 516 is made by combining secondary color 508 with primary color 504; tertiary color 518 is made by combining primary color 504 with secondary color 510; tertiary color 520 is made by combining secondary color 510 with primary color 506; tertiary color 522 is made by combining primary color 506 with secondary color 512; and tertiary color 524 is made by combining secondary color 512 with primary color 502.

When painting, an artist mixes colors of paints to achieve new colors through the subtractive color method. Therefore, color harmony tends to be defined by relative relationships among colors on a subtractive color model color wheel.

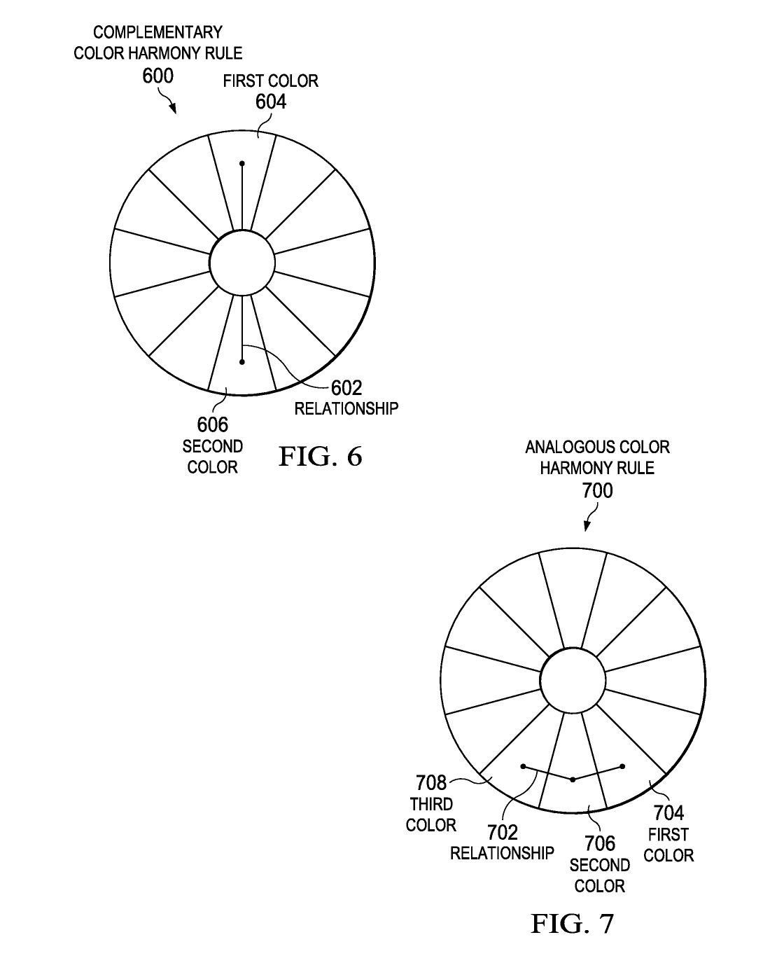

Referring now to FIG. 6, an illustration of a complementary color harmony rule graphically displayed on a red-blue-yellow color wheel for identifying harmonious colors is depicted in accordance with an illustrative embodiment. Complementary color harmony rule 600 is an example of a color harmony rule, such as one of color harmony rules 300 of FIG. 3, displayed on a subtractive color model color wheel, such as color wheel 500 of FIG. 5.

As depicted, complementary color harmony rule 600 defines a relationship 602 between first color 604 and second color 606. Relationship 602 specifies a relative position of first color 604 and second color 606.

As depicted, first color 604 and second color 606 can be any set of two colors defined by relationship 602. In the context of color wheel 500, the set of colors can include: primary color 502 and secondary color 510; primary color 504 and secondary color 512; primary color 506 and secondary color 508; tertiary color 514 and tertiary color 521; tertiary color 516 and tertiary color 522; and tertiary color 518 and tertiary color 524.

Referring now to FIG. 7, an illustration of an analogous color harmony rule graphically displayed on a red-blue-yellow color wheel for identifying harmonious colors is depicted in accordance with an illustrative embodiment. Analogous color harmony rule 700 is an example of a color harmony rule, such as one of color harmony rules 300 of FIG. 3, displayed on a subtractive color model color wheel, such as color wheel 500 of FIG. 5.

As depicted, analogous color harmony rule 700 defines relationship 702 between first color 704, second color 706, and third color 708. Relationship 702 specifies a relative position of first color 704, second color 706, and third color 708.

As depicted, first color 704, second color 706, and third color 708 can be any set of three colors defined by relationship 702. In the context of color wheel 500, the set of colors can include: primary color 502, tertiary color 514, and secondary color 508; tertiary color 514, secondary color 508, and tertiary color 516; secondary color 508, tertiary color 516, and primary color 504; tertiary color 516, primary color 504, and tertiary color 518; primary color 504, tertiary color 518, and secondary color 510; tertiary color 518, secondary color 510, and tertiary color 520; secondary color 510, tertiary color 520, and primary color 506; tertiary color 520, primary color 506, and tertiary color 522; primary color 506, tertiary color 522, and secondary color 512; tertiary color 522, secondary color 512, and tertiary color 524; secondary color 512, tertiary color 524, and primary color 502; and tertiary color 524, primary color 502, and tertiary color 514.

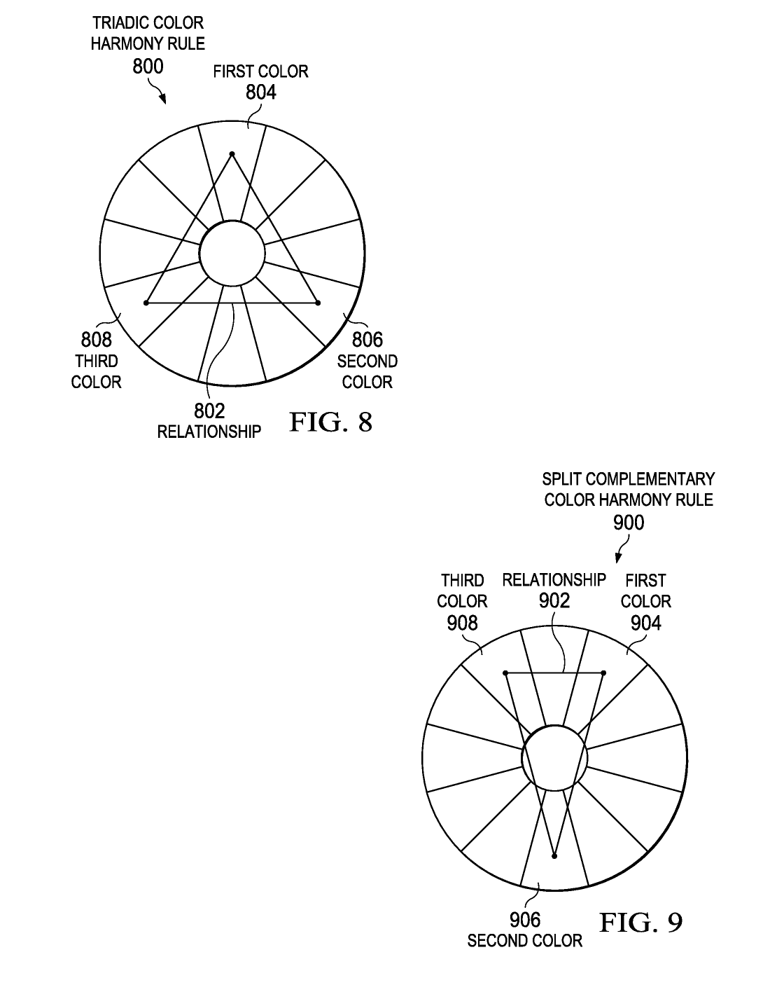

Referring now to FIG. 8, an illustration of a triadic color harmony rule graphically displayed on a red-blue-yellow color wheel for identifying harmonious colors is depicted in accordance with an illustrative embodiment. Triadic color harmony rule 800 is an example of the color harmony rules, such as one of color harmony rules 300 of FIG. 3, displayed on a subtractive color model color wheel, such as color wheel 500 of FIG. 5.

As depicted, triadic color harmony rule 800 defines a relationship 802 between first color 804, second color 806, and third color 808. Relationship 802 specifies a relative position of first color 804, second color 806, and third color 808.

As depicted, first color 804, second color 806, and third color 808 can be any set of three colors defined by relationship 802. In the context of color wheel 500, a set of colors can include: primary color 502, primary color 504, and primary color 506; secondary color 508, secondary color 510, and secondary color 512; tertiary color 514, tertiary color 518, and tertiary color 522; and tertiary color 516, tertiary color 520, and tertiary color 524.

Referring now to FIG. 9, an illustration of a split-complementary color harmony rule graphically displayed on a red-blue-yellow color wheel for identifying harmonious colors is depicted in accordance with an illustrative embodiment. Split complementary color harmony rule 900 is an example of color harmony rules, such as one of color harmony rules 300 of FIG. 3, displayed on a subtractive color model color wheel, such as color wheel 500 of FIG. 5.

As depicted, split complementary color harmony rule 900 defines a relationship 902 between first color 904, second color 906, and third color 908. Relationship 902 specifies a relative position of first color 904, second color 906, and third color 908 on color wheel 500.

As depicted, first color 904, second color 906, and third color 908 can be any set of three colors defined by relationship 902. In the context of color wheel 500, a set of colors can include: primary color 502, tertiary color 518, and tertiary color 520; tertiary color 514, secondary color 510, and primary color 506; secondary color 508, tertiary color 520, and tertiary color 522; tertiary color 516, primary color 506, and secondary color 512; primary color 504, tertiary color 522, and tertiary color 524; tertiary color 518, secondary color 512, and primary color 502; secondary color 510, tertiary color 524, and tertiary color 514; tertiary color 520, primary color 502, and secondary color 508; primary color 506, tertiary color 514, and tertiary color 516; tertiary color 522, secondary color 508, and primary color 504; secondary color 512, tertiary color 516, and tertiary color 518; and tertiary color 524, primary color 504, and secondary color 510.

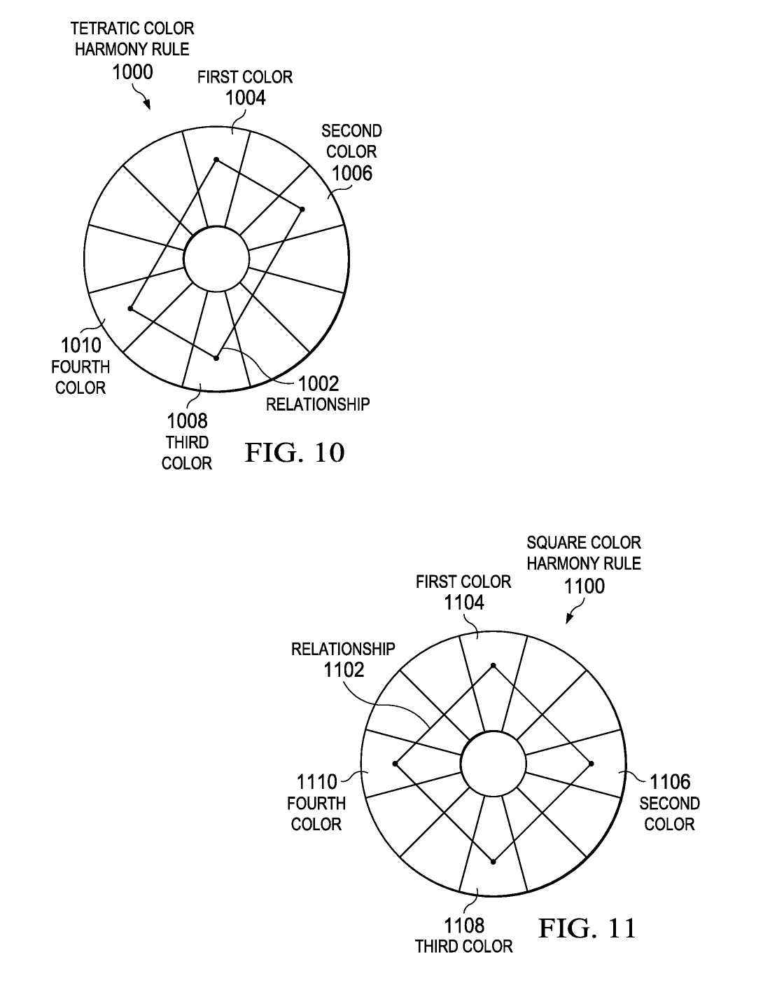

Referring now to FIG. 10, an illustration of a tetratic color harmony rule graphically displayed on a red-blue-yellow color wheel for identifying harmonious colors is depicted in accordance with an illustrative embodiment. Tetratic color harmony rule 1000 is an example of a color harmony rule, such as one of color harmony rules 300 of FIG. 3, displayed on a subtractive color model color wheel, such as color wheel 500 of FIG. 5.

As depicted, tetratic color harmony rule 1000 defines relationship 1002 between first color 1004, second color 1006, third color 1008, and fourth color 1010. Relationship 1002 specifies a relative position of first color 1004, second color 1006, third color 1008, and fourth color 1010 on color wheel 500.

As depicted, first color 1004, second color 1006, third color 1008, and fourth color 1010 can be any set of four colors defined by relationship 1002. In the context of color wheel 500, a set of colors can include: primary color 502, secondary color 508, secondary color 510, and primary color 506; tertiary color 514, tertiary color 516, tertiary color 520, and tertiary color 522; secondary color 508, primary color 504, primary color 506, and secondary color 512; tertiary color 516, tertiary color 518, tertiary color 522, and tertiary color 524; primary color 504, secondary color 510, secondary color 512, and primary color 502; and tertiary color 518, tertiary color 520, tertiary color 524, and tertiary color 514.

Referring now to FIG. 11, an illustration of a square color harmony rule graphically displayed on a red-blue-yellow color wheel for identifying harmonious colors is depicted in accordance with an illustrative embodiment. Square color harmony rule 1100 is an example of a color harmony rules, such as one of color harmony rules 300 of FIG. 3, displayed on a subtractive color model color wheel, such as color wheel 500 of FIG. 5.

As depicted, square color harmony rule 1100 defines relationship 1102 between first color 1104, second color 1106, third color 1108, and fourth color 1110. Relationship 1102 specifies a relative position of first color 1104, second color 1106, third color 1108, and fourth color 1110 on color wheel 500.

As depicted, first color 1104, second color 1106, third color 1108, and fourth color 1110 can be any set of four colors defined by relationship 1102. In the context of color wheel 500, a set of colors can include: primary color 502, tertiary color 516, secondary color 510, and tertiary color 522; tertiary color 514, primary color 504, tertiary color 520, and secondary color 512; and secondary color 508, tertiary color 518, primary color 506, and tertiary color 524.

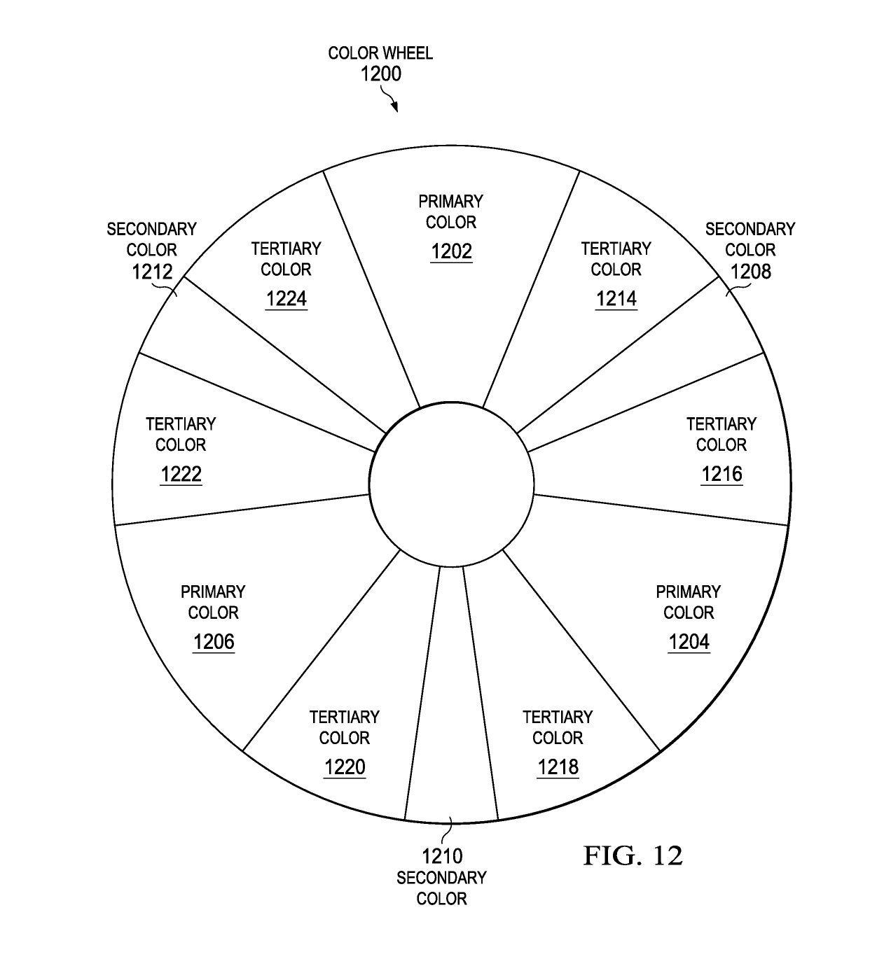

Referring now to FIG. 12, an illustration of a subtractive color model color wheel for identifying harmonious colors is depicted in accordance with an illustrative embodiment. In this figure, color wheel 1200 is as an example of red-green-blue additive color model color wheel for displaying harmonious colors according to a policy, such as policy 142 of FIG. 1.

Additive color models create different colors by mixing colors of light in various ways to reproduce a broad array of colors. Additive color processes work by superimposing the wavelengths of different color primary light beams to make the final color's spectrum. Each of the primary beams is called a component of that color, and each of them can have an arbitrary intensity, from fully off to fully on.

When the intensities for all the components are the same, the result is a shade of gray, darker or lighter depending on the intensity. Zero intensity for each component produces no light and is considered the black. Full intensity for each component produces a white color. When the intensities for the components different, the result is a colorized hue, more or less saturated depending on the difference of the strongest and weakest of the intensities of the primary colors employed.

Color wheel 1200 includes primary colors 1202, 1204, and 1206. Primary colors are sets of colors that can be combined to make a useful range of colors. Color wheel 1200 uses a red-green-blue additive color model. When one of the components has the strongest intensity, the color is a hue near this primary color. In this illustrative example, color wheel 1200 includes primary colors 1202, 1204, and 1206 corresponding to the colors red, green, and blue.

Color wheel 1200 includes secondary colors 1208, 1210, and 1212. Secondary colors are sets of colors that are made by combining equal intensities of two different primary colors. If two components have the same strongest intensity, then the color is a hue of a secondary color. In this illustrative example, secondary color 1208 is made by combining primary color 1202 and primary color 1204; secondary color 1210 is made by combining primary color 1204 and primary color 1206; and secondary color 1212 is made by combining primary color 1206 and primary color 1202. Color wheel 1200 uses a red-green-blue additive color model. Therefore, color wheel 1200 includes secondary colors 1208, 1210, and 1212 corresponding to the colors yellow, cyan, and magenta.

Color wheel 1200 includes tertiary colors 1214, 1216, 1218, 1220, 1222, and 1224. Tertiary colors are sets of colors that are made by combining different intensities of two different primary colors. In this illustrative example, tertiary color 1214 is made by combining a more intense primary color 1202 with a less intense primary color 1204; tertiary color 1216 is made by combining a more intense primary color 1204 with a less intense primary color 1202; tertiary color 1218 is made by combining a more intense primary color 1204 with a less intense primary color 1206; tertiary color 1220 is made by combining a more intense primary color 1206 with a less intense primary color 1204; tertiary color 1222 is made by combining a more intense primary color 1206 with a less intense primary color 1202; and tertiary color 1224 is made by combining a more intense primary color 1202 with a less intense primary color 1206.

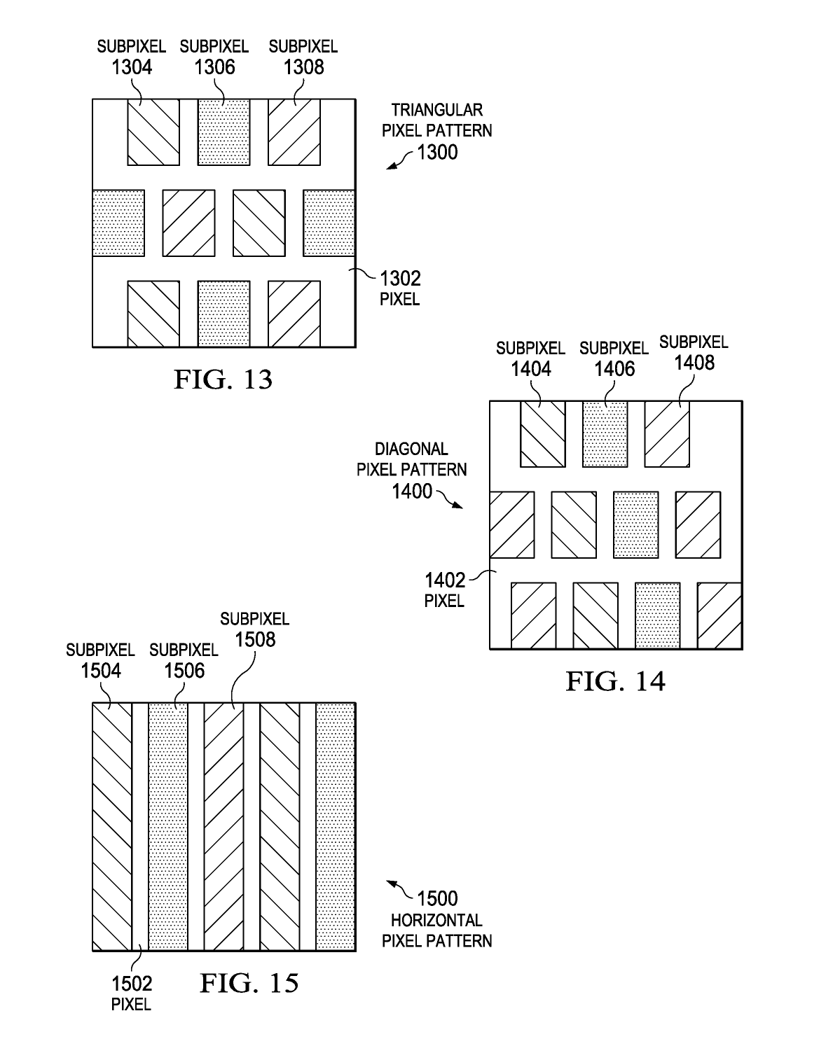

Referring now to FIGS. 13-15, an illustration of a series of pixels arranged according to a first pixel pattern for displaying the generated color palette is shown according to an illustrative embodiment. The pixel patterns of FIGS. 13-16 are used to reproduce a selected palette 124 on a display system 122, both shown in block form in FIG. 1.

In digital imaging, a pixel, pel, or picture element is the smallest controllable element of a picture represented on the screen. Each pixel is a sample of an original image; more samples typically provide more accurate representations of the original. The intensity of each pixel is variable. In color image systems, a color is typically represented by three or four component intensities such as red, green, and blue, or cyan, magenta, yellow, and black.

Many display and image-acquisition systems are, for various reasons, not capable of displaying or sensing the different color channels at the same site. Therefore, the pixel grid is divided into single-color regions that contribute to the displayed or sensed color when viewed at a distance. In some displays, such as LCD, LED, and plasma displays, these single-color regions are separately addressable elements, which have come to be known as subpixels.

Referring now specifically to FIG. 13, triangular pixel pattern 1300 is shown. Triangular pixel pattern 1300 includes a plurality of pixels 1302. Each of pixels 1302 includes subpixels 1304, 1306, and 1308. Pixel 1302 combines the single color region of subpixel 1304, 1306, and 1308 by varying the intensity of each component. When viewed at a distance, pixel 1302 appears to have a color based on the combined wavelengths and intensities of subpixel 1304, 1306, and 1308.

Referring now specifically to FIG. 14, diagonal pixel pattern 1400 is shown. Diagonal pixel pattern 1400 includes a plurality of pixels 1402. Each of pixels 1402 includes subpixels 1404, 1406, and 1408. Pixel 1402 combines the single color region of subpixel 1404, 1406, and 1408 by varying the intensity of each component. When viewed at a distance, pixel 1402 appears to have a color based on the combined wavelengths and intensities of subpixel 1404, 1406, and 1408.

Referring now specifically to FIG. 15, horizontal pixel pattern 1500 is shown. Horizontal pixel pattern 1500 includes a plurality of pixels 1502. Each of pixels 1502 includes subpixels 1504, 1506, and 1508. Pixel 1502 combines the single color region of subpixel 1504, 1506, and 1508 by varying the intensity of each component. When viewed at a distance, pixel 1502 appears to have a color based on the combined wavelengths and intensities of subpixel 1504, 1506, and 1508.

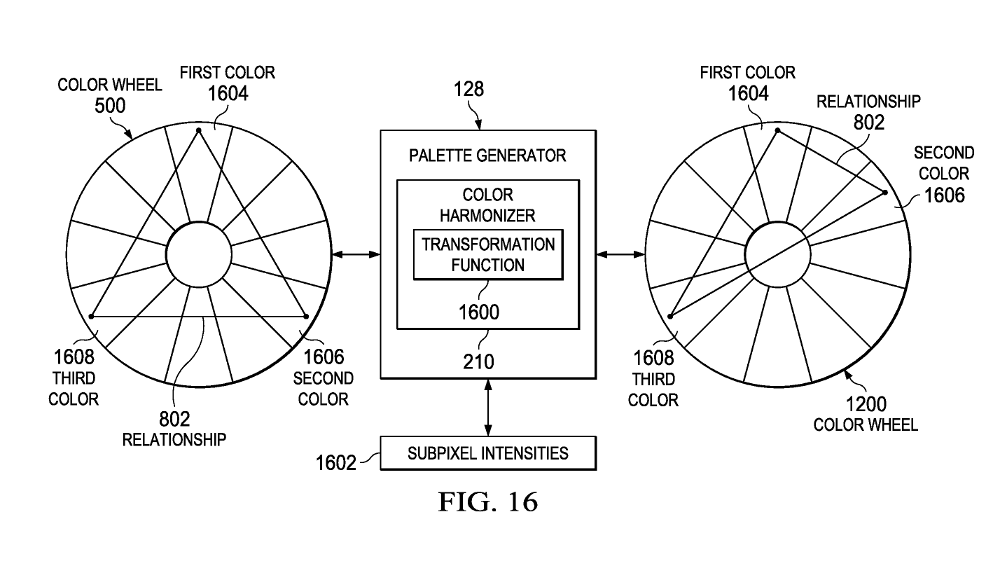

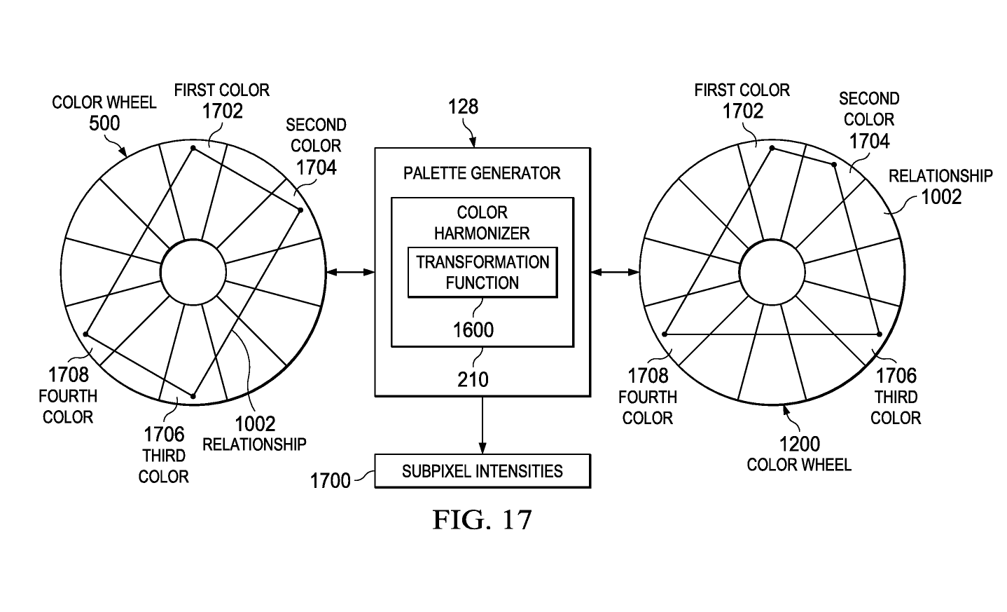

With reference next to FIGS. 16 and 17, an illustration of a block diagram of a data flow for identifying a color palette for displaying a graphical user interface on the display system according to a set of color harmony rules is shown according to an illustrative embodiment.

When painting, an artist mixes colors of paints to achieve new colors through the subtractive color method. Therefore, color harmony tends to be defined by relative relationships among colors on a subtractive color model color wheel.

In the illustrative examples, palette generator 128 includes transformation function 1600. Transformation function 1600 is a function within color harmonizer 210 that transforms relative relationships among colors on a subtractive color model color wheel into the corresponding pixel intensities for display on an additive color model display system, such as display system 122 of FIG. 1.

With reference specifically to FIG. 16, an illustration of a block diagram of a data flow for identifying a color palette according to a triadic color harmony rules is shown according to an illustrative embodiment. In this figure, transformation function 1600 identifies subpixel intensities 1602 based on relationship 802 depicted on color wheel 500.

First color 1604 is displayed on color wheel 1200. In this illustrative example, first color 1604 is represented as a combination of intensities generated by subpixels, such as subpixel 1504, 1506, and 1508 of FIG. 15. When displayed on display system 122, first color 1604 appears to have a color based on the combined wavelengths and intensities of those subpixels. In this illustrative example, first color 1604 can be represented by a three-byte hexadecimal number with each byte representing the intensity of a corresponding color component. In this illustrative example, first color 1604 is represented by the three-byte hexadecimal number:
#ff0000

In this first illustrative example, first color 1604 appears as “red” when displayed on a display system, such as display system 122 of FIG. 1.

Palette generator 128 applies transformation function 1600 to first color 1604 to identify second color 1606 and third color 1608. Second color 1606 and third color 1608 are identified based on known first color 1604 and relationship 802 defined by triadic color harmony rules 800 of FIG. 8.

Palette generator 128 applies transformation function 1600 to identify subpixel intensities 1602 for each of second color 1606 defined by relationship 802. In this illustrative example, second color 1606 is represented by the three-byte hexadecimal number:
#ffff00

In this first illustrative example, second color 1606 appears as “green” when displayed on a display system, such as display system 122 of FIG. 1.

Palette generator 128 applies transformation function 1600 to identify subpixel intensities 1602 for each of third color 1608 defined by relationship 802. In this illustrative example, third color 1608 is represented by the three-byte hexadecimal number:
#0000ff

In this first illustrative example, third color 1608 appears as “blue” when displayed on a display system, such as display system 122 of FIG. 1.

In a second illustrative example, both first color 1604 and second color 1606 are known. In this illustrative example, first color 1604 is represented by the three-byte hexadecimal number:
#ff0000

First color 1604 appears as “red” when displayed on a display system, such as display system 122 of FIG. 1.

In this illustrative example, second color 1606 is represented by the three-byte hexadecimal number:
#ffff00

In this illustrative example, second color 1606 appears as “yellow” when displayed on a display system, such as display system 122 of FIG. 1.

In this illustrative example, transformation function 1600 identifies one or more color harmony rules that define a relationship are closely approximated by the relative positions of first color 1604 and second color 1606 as displayed on color wheel 500. In this illustrative example, transformation function 1600 identifies relationship 802.

Palette generator 128 applies transformation function 1600 to identify subpixel intensities 1602 for third color 1608 defined by relationship 802 identified from known first color 1604 and known second color 1606. In this illustrative example, third color 1608 is represented by the three-byte hexadecimal number:
#0000ff

In this illustrative example, third color 1608 appears as “blue” when displayed on a display system, such as display system 122 of FIG. 1.

While FIG. 16 shows only the identification and application of a single color harmony rules, such as for illustrative purposes only. The dataflow depicted in FIG. 16 can be used to identify and apply other color harmony rules to other identified colors, such as but not limited to complementary color harmony rule 600, analogous color harmony rule 700, triadic color harmony rule 800, split complementary color harmony rule 900, tetratic color harmony rule 1000, and square color harmony rule 1100.

With reference specifically to FIG. 17, an illustration of a block diagram of a data flow for identifying a color palette according to a tetratic color harmony rules is shown according to an illustrative embodiment. In this figure, transformation function 1600 identifies of subpixel intensities 1700 based on relationship 1002 depicted on color wheel 500.

First color 1702 is displayed on color wheel 1200. This illustrative example, first color 1702 is represented as a combination of intensities generated by sub pixels, such as subpixel 1504, 1506, and 1508 of FIG. 15. When displayed on display system 122, first color 1702 appears to have a color based on the combined wavelengths and intensities of those subpixels. In this illustrative example, first color 1702 can be represented by a three-byte hexadecimal number with each byte representing the intensity of a corresponding color component. In this illustrative example, first color 1702 is represented by the three-byte hexadecimal number:
#ff0000

In this first illustrative example, first color 1702 appears as “red” when displayed on a display system, such as display system 122 of FIG. 1.

Palette generator 128 applies transformation function 1600 to first color 1702 to identify second color 1704, third color 1706, and fourth color 1708. Second color 1704, third color 1706, and fourth color 1708 are identified based on known first color 1702 and relationship 1002 defined by tetratic color harmony rules 1000.

Palette generator 128 applies transformation function 1600 to identify subpixel intensities 1602 for each of second color 1704 defined by relationship 1002. In this illustrative example, second color 1704 is represented by the three-byte hexadecimal number:
#ff8000

In this first illustrative example, second color 1704 appears as “orange” when displayed on a display system, such as display system 122 of FIG. 1.

Palette generator 128 applies transformation function 1600 to identify subpixel intensities 1602 for each of third color 1706 defined by relationship 1002. In this illustrative example, third color 1706 is represented by the three-byte hexadecimal number:
#00ff00

In this first illustrative example, third color 1706 appears as “green” when displayed on a display system, such as display system 122 of FIG. 1.

Palette generator 128 applies transformation function 1600 to identify subpixel intensities 1602 for each of fourth color 1708 defined by relationship 1002. In this illustrative example, fourth color 1708 is represented by the three-byte hexadecimal number:
#0000ff

In this first illustrative example, fourth color 1708 appears as “blue” when displayed on a display system, such as display system 122 of FIG. 1.

In a second illustrative example, both first color 1702 and second color 1704 are known. In this illustrative example, first color 1702 is represented by the three-byte hexadecimal number:
#ff0000

First color 1702 appears as “red” when displayed on a display system, such as display system 122 of FIG. 1.

In this illustrative example, second color 1704 is represented by the three-byte hexadecimal number:
#ff8000

In this illustrative example, second color 1704 appears as “orange” when displayed on a display system, such as display system 122 of FIG. 1.

In this illustrative example, transformation function 1600 identifies one or more color harmony rules that define a relationship are closely approximated by the relative positions of first color 1702 and second color 1704 as displayed on color wheel 500. In this illustrative example, transformation function 1600 identifies relationship 1002.

Palette generator 128 applies transformation function 1600 to identify subpixel intensities 1602 for third color 1706 defined by relationship 802 identified from known first color 1604 and known second color 1606. In this illustrative example, third color 1706 is represented by the three-byte hexadecimal number:
#00ff00

In this illustrative example, third color 1706 appears as “green” when displayed on a display system, such as display system 122 of FIG. 1.

Palette generator 128 applies transformation function 1600 to identify subpixel intensities 1602 for fourth color 1708 defined by relationship 802 identified from known first color 1604 and known second color 1606. In this illustrative example, fourth color 1708 is represented by the three-byte hexadecimal number:
#0000ff

In this illustrative example, fourth color 1708 appears as “blue” when displayed on a display system, such as display system 122 of FIG. 1.

While FIG. 17 shows only the identification and application of a single color harmony rules, such as for illustrative purposes only. The dataflow depicted in FIG. 16 can be used to identify and apply other color harmony rules to other identified colors, such as but not limited to complementary color harmony rule 600, analogous color harmony rule 700, triadic color harmony rule 800, split complementary color harmony rule 900, tetratic color harmony rule 1000, and square color harmony rule 1100.

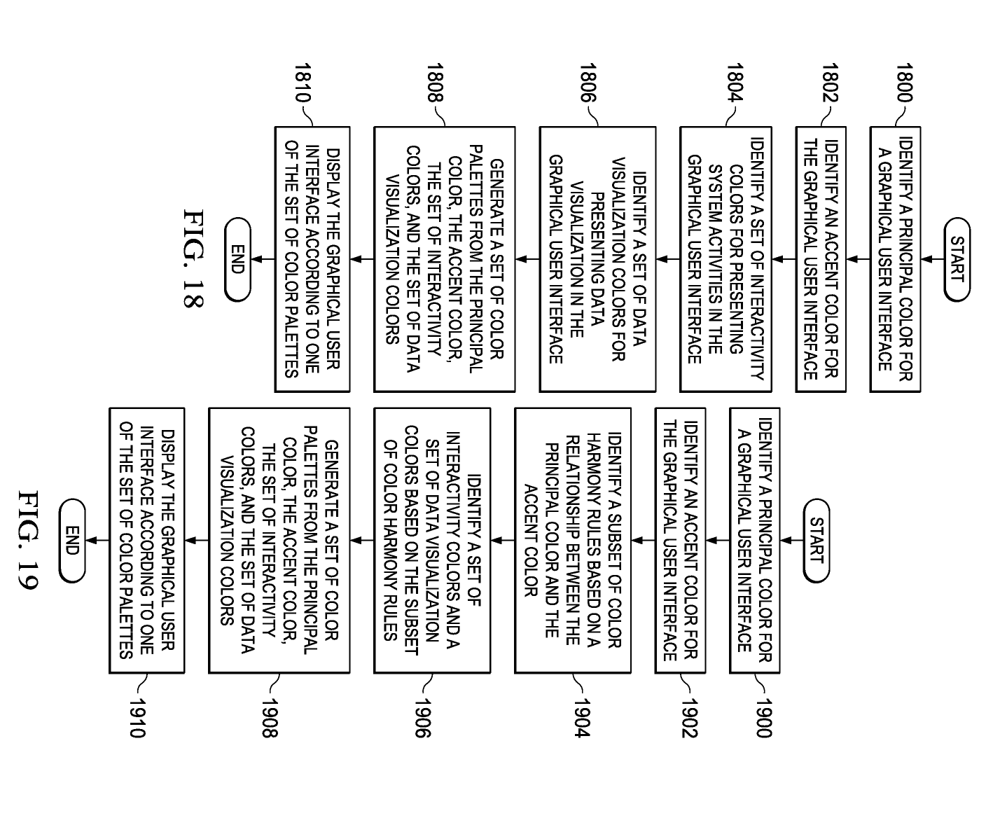

Turning next to FIG. 18, an illustration of a flowchart of a process for generating a set of color palettes for displaying a graphical user interface is depicted in accordance with an illustrative embodiment. The process illustrated in FIG. 18 may be implemented in palette generation environment 100 shown in block form in FIG. 1. This process may be used to enable operations for organization 106. In particular, the process may be implemented in palette generator 128 in computer system 130.

The process begins by identifying a principal color for a graphical user interface to be displayed on display system (step 1800). The process then identifies an accent color for the graphical user interface to be displayed on the display system (step 1802).

The process identifies a set of interactivity colors for presenting system activities in the graphical user interface (step 1804). The set of interactivity colors are identified based on application of a set of rules to at least one of the principal color and the accent color. In an illustrative example, the set of interactivity colors can be identified based on application of one or more color harmony rules to at least one of the principal color and the accent color. The color harmony rules can be selected from the group consisting of a complementary harmony, an analogous harmony, a triadic harmony, a split complementary harmony, a tetratic harmony, and a square harmony.

The process identifies a set of data visualization colors for presenting data visualization in the graphical user interface (step 1806). The set of data visualization colors are identified based on an application of a set of rules to at least one of the principal color, the accent color, and a set of interactivity colors. In an illustrative embodiment, the set of data visualization colors can be identified based on application of a set of color harmony rules to at least one of the principal color, the accent color, and the set of interactivity colors. In an illustrative example, the set of data visualization colors can be identified based on application of one or more color harmony rules to at least one of the principal color and the accent color. The color harmony rules can be selected from the group consisting of a complementary harmony, an analogous harmony, a triadic harmony, a split complementary harmony, a tetratic harmony, and a square harmony.

The process generates a set of color palettes from the principal color, the accent color, the set of interactivity colors, and the set of data visualization colors (step 1808). The process then displays the graphical user interface according to one of the set of color palettes (step 1810), with the process terminating thereafter. In this manner, performing an action in the organization based on a customized color palettes for displaying a graphical user interface on a display system of the organization is enabled.

Turning now to FIG. 19, an illustration of a flowchart of a process for generating a set of color palettes based on a relationship between a principal color and an accent color is depicted in accordance with an illustrative embodiment. The process illustrated in FIG. 19 may be implemented in palette generation environment 100 shown in block form in FIG. 1. This process may be used to enable operations for organization 106. In particular, the process may be implemented in palette generator 128 in computer system 130.

The process begins by identifying a principal color for a graphical user interface to be displayed on display system (step 1900). The process then identifies an accent color for the graphical user interface to be displayed on the display system (step 1902).

The process then identifies a subset of color harmony rules based on a relationship between the principal color and the accent color (step 1904). In an illustrative example, the color harmony rules can be selected from the group consisting of a complementary harmony, an analogous harmony, a triadic harmony, a split complementary harmony, a tetratic harmony, and a square harmony. The subset of the color harmony rules of those rules that define a relationship that matches the relationship between the principal color and the accent color.

The process identifies a set of interactivity colors and a set of data visualization based on the subset of color harmony rules (step 1906). The set of interactivity colors are identified based on application of the subset of color harmony rules to at least one of the principal color and the accent color. The set of data visualization colors are identified based on an application of the subset of color harmony rules to at least one of the principal color, the accent color, and a set of interactivity colors.

The process generates a set of color palettes from the principal color, the accent color, the set of interactivity colors, and the set of data visualization colors (step 1908). The process then displays the graphical user interface according to one of the set of color palettes (step 1910), with the process terminating thereafter. In this manner, performing an action in the organization based on a customized color palettes for displaying a graphical user interface on a display system of the organization is enabled.

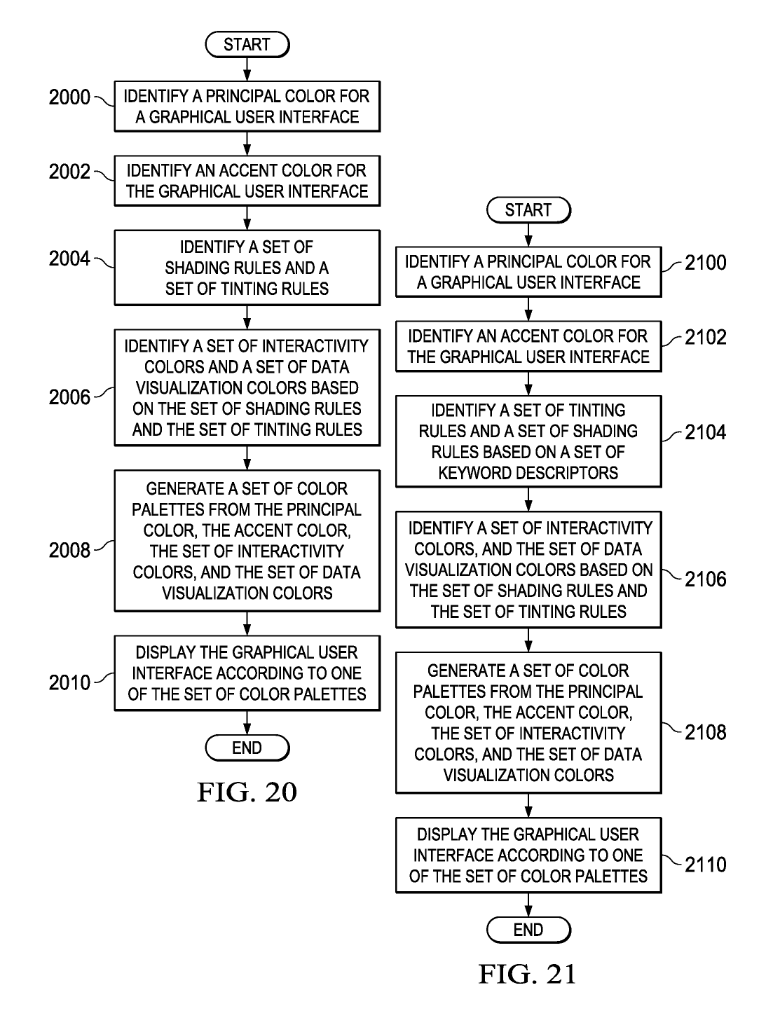

Turning now to FIG. 20, an illustration of a flowchart of a process for generating a set of color palettes by applying shading rules and tinting rules to a principal color and an accent color is depicted in accordance with an illustrative embodiment. The process illustrated in FIG. 20 may be implemented in palette generation environment 100 shown in block form in FIG. 1. This process may be used to enable operations for organization 106. In particular, the process may be implemented in palette generator 128 in computer system 130.

The process begins by identifying a principal color for a graphical user interface to be displayed on display system (step 2000). The process then identifies an accent color for the graphical user interface to be displayed on the display system (step 2002).

The process then identifies a set of shading rules and a set of tinting rules (step 2004). In this illustrative example, the set of shading rules are rules that create new colors by darkening at least one of the principal color and the secondary color without changing the color's hue. The set of tinting rules are rules that create new colors by lightening at least one of the principal color and the secondary color without changing the color's hue.

The process identifies a set of interactivity colors and a set of data visualization based on the set of shading rules and the set of tinting rules (step 2006). In an illustrative embodiment, the set of interactivity colors can be identified based on application of at least one of the set of shading rules and the set of tinting rules to at least one of the principal color, and the accent color. In an illustrative example, the set of data visualization colors can be identified based on application of at least one of the set of shading rules and the set of tinting rules to at least one of the principal color, the accent color, and the set of interactivity colors.

The process generates a set of color palettes from the principal color, the accent color, the set of interactivity colors, and the set of data visualization colors (step 2008). The process then displays the graphical user interface according to one of the set of color palettes (step 2010), with the process terminating thereafter. In this manner, performing an action in the organization based on a customized color palettes for displaying a graphical user interface on a display system of the organization is enabled.

Turning now to FIG. 21, an illustration of a flowchart of a process for generating a set of color palettes by applying shading rules and tinting rules to a principal color and an accent color is depicted in accordance with an illustrative embodiment. The process illustrated in FIG. 21 may be implemented in palette generation environment 100 shown in block form in FIG. 1. This process may be used to enable operations for organization 106. In particular, the process may be implemented in palette generator 128 in computer system 130.

The process begins by identifying a principal color for a graphical user interface to be displayed on display system (step 2100). The process then identifies an accent color for the graphical user interface to be displayed on the display system (step 2102).

The process then identifies a set of shading rules and a set of tinting rules based on a set of keyword descriptors (step 2104). In this illustrative example, the set of shading rules are rules that create new colors by darkening at least one of the principal color and the secondary color without changing the color's hue. The set of tinting rules are rules that create new colors by lightening at least one of the principal color and the secondary color without changing the color's hue.

In this illustrative example, keyword descriptors are descriptions submitted by an organization describing projected traits of at least one of the organization and services offered by the organization. As depicted, the keyword descriptors can be keyword descriptors 406, depicted in block form in FIG. 4.

The process identifies a set of interactivity colors and a set of data visualization based on the set of shading rules and the set of tinting rules (step 2106). In an illustrative embodiment, the set of interactivity colors can be identified based on application of at least one of the set of shading rules and the set of tinting rules to at least one of the principal color, and the accent color. In an illustrative example, the set of data visualization colors can be identified based on application of at least one of the set of shading rules and the set of tinting rules to at least one of the principal color, the accent color, and the set of interactivity colors.

The process generates a set of color palettes from the principal color, the accent color, the set of interactivity colors, and the set of data visualization colors (step 2108). The process then displays the graphical user interface according to one of the set of color palettes (step 2110), with the process terminating thereafter. In this manner, performing an action in the organization based on a customized color palettes for displaying a graphical user interface on a display system of the organization is enabled.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

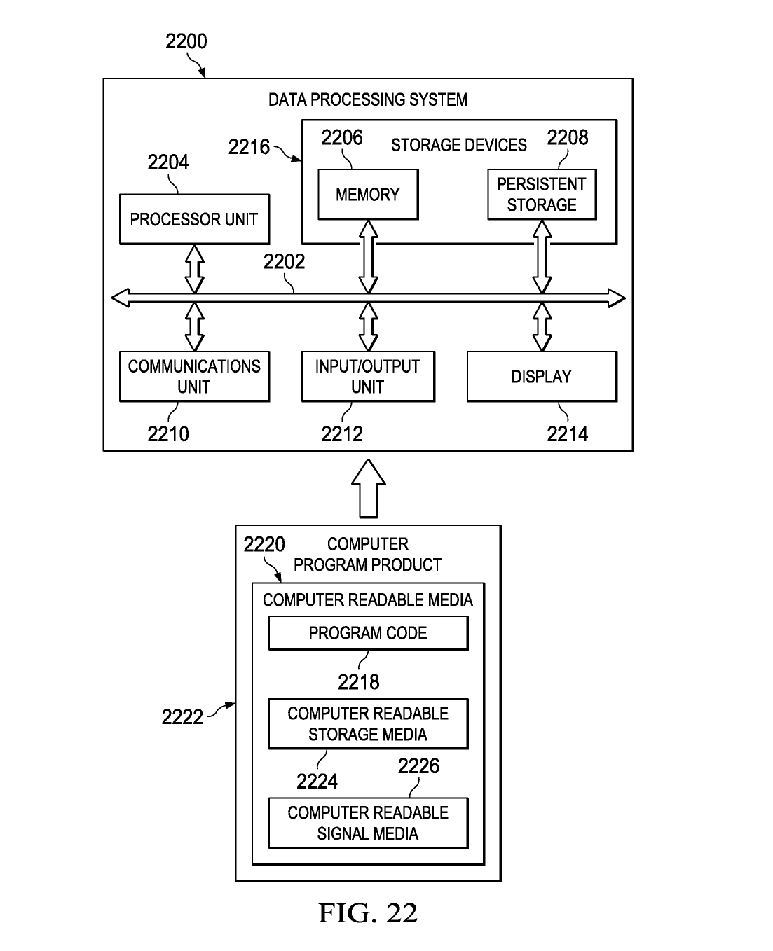

Turning now to FIG. 22, an illustration of a block diagram of a data processing system is depicted in accordance with an illustrative embodiment. Data processing system 2200 may be used to implement computer system 130 in FIG. 1. In this illustrative example, data processing system 2200 includes communications framework 2202, which provides communications between processor unit 2204, memory 2206, persistent storage 2208, communications unit 2210, input/output unit 2212, and display 2214. In this example, communications framework 2202 may take the form of a bus system.

Processor unit 2204 serves to execute instructions for software that may be loaded into memory 2206. Processor unit 2204 may be a number of processors, a multi-processor core, or some other type of processor, depending on the particular implementation.

Memory 2206 and persistent storage 2208 are examples of storage devices 2216. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 2216 may also be referred to as computer readable storage devices in these illustrative examples. Memory 2206, in these examples, may be, for example, a random access memory or any other suitable volatile or non-volatile storage device. Persistent storage 2208 may take various forms, depending on the particular implementation.

For example, persistent storage 2208 may contain one or more components or devices. For example, persistent storage 2208 may be a hard drive, a flash memory, a rewritable optical disk, a rewritable magnetic tape, or some combination of the above. The media used by persistent storage 2208 also may be removable. For example, a removable hard drive may be used for persistent storage 2208.

Communications unit 2210, in these illustrative examples, provides for communications with other data processing systems or devices. In these illustrative examples, communications unit 2210 is a network interface card.

Input/output unit 2212 allows for input and output of data with other devices that may be connected to data processing system 2200. For example, input/output unit 2212 may provide a connection for user input through at least of a keyboard, a mouse, or some other suitable input device. Further, input/output unit 2212 may send output to a printer. Display 2214 provides a mechanism to display information to a user.

Instructions for at least one of the operating system, applications, or programs may be located in storage devices 2216, which are in communication with processor unit 2204 through communications framework 2202. The processes of the different embodiments may be performed by processor unit 2204 using computer-implemented instructions, which may be located in a memory, such as memory 2206.

These instructions are referred to as program code, computer usable program code, or computer readable program code that may be read and executed by a processor in processor unit 2204. The program code in the different embodiments may be embodied on different physical or computer readable storage media, such as memory 2206 or persistent storage 2208.

Program code 2218 is located in a functional form on computer readable media 2220 that is selectively removable and may be loaded onto or transferred to data processing system 2200 for execution by processor unit 2204. Program code 2218 and computer readable media 2220 form computer program product 2222 in these illustrative examples. In one example, computer readable media 2220 may be computer readable storage media 2224 or computer readable signal media 2226.

In these illustrative examples, computer readable storage media 2224 is a physical or tangible storage device used to store program code 2218 rather than a medium that propagates or transmits program code 2218. Alternatively, program code 2218 may be transferred to data processing system 2200 using computer readable signal media 2226. Computer readable signal media 2226 may be, for example, a propagated data signal containing program code 2218. For example, computer readable signal media 2226 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 2200 are not meant to provide architectural limitations to the manner in which different embodiments may be implemented. The different illustrative embodiments may be implemented in a data processing system including components in addition to or in place of those illustrated for data processing system 2200. Other components shown in FIG. 22 can be varied from the illustrative examples shown. The different embodiments may be implemented using any hardware device or system capable of running program code 2218.

Thus, the illustrative examples in the different figures provide one or more technical solutions to overcome a technical problem of developing and designing a visual composition of a graphical user interface that is consistent with an organizational image that make for the efficient performance of operations in an information system more cumbersome and time-consuming than desired. For example, palette generator 128 adds palette 132 to set of palettes 126 when a relationship between principal color 134, accent color 136, interactivity colors 138, and data visualization colors 140 meets one or more rules in policy 142.

In this manner, the use of palette generator 128 has a technical effect of reducing time, effort, or both in identifying palette 132 for harmoniously displaying graphical user interface 120, and information 104 therein, on display system 122. In this manner, operation 150 performed for organization 106 may be performed more efficiently as compared to currently used systems. For example, selected palette 124 may be used to display information 104, enabling more efficient performance of operation 150, selected from at least one of hiring, benefits administration, payroll, performance reviews, forming teams for new products, assigning research projects, or other suitable operations for organization 106.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A method for generating a set of color palettes for displaying a graphical user interface, the method comprising:
identifying, by a computer system, a predominant color within an image, wherein the image is a logo for a corporation;
identifying, by the computer system, a principal color for a graphical user interface to be displayed on a display system based on an application of a set of color harmony rules to the predominant color identified within the image;
identifying, by the computer system, a secondary color within the image;
identifying, by the computer system, an accent color for the graphical user interface based on an application of the set of color harmony rules to the secondary color identified within the image;
receiving a set of key-word descriptors for projected traits of the corporation;
associating the set of key-word descriptors with a subset of a set of shading rules and a set of tinting rules;
identifying, by the computer system, a set of interactivity colors for presenting system activities in the graphical user interface, wherein the set of interactivity colors are identified based on an application of the subset of the set of shading rules and the set of tinting rules to at least one of the principal color and the accent color;
identifying, by the computer system, a set of data visualization colors for presenting data visualization in the graphical user interface, wherein the set of data visualization colors are identified based on an application of the subset of the set of shading rules and the set of tinting rules to at least one of the principal color, the accent color, and the set of interactivity colors;
generating, by the computer system, a set of color palettes from the principal color, the accent color, the set of interactivity colors, and the set of data visualization colors; and
displaying, by the computer system, the graphical user interface according to one of the set of color palettes.

2. The method of claim 1, wherein the set of color harmony rules specify fixed relationships between two or more colors in a color wheel.

3. The method of claim 2, wherein the set of color harmony rules is selected from the group consisting of a complementary harmony, an analogous harmony, a triadic harmony, a split complementary harmony, a tetratic harmony, and a square harmony.

4. The method of claim 3, wherein the step of identifying the accent color further comprises:
identifying, by the computer system, the accent color for the graphical user interface on the display system based on an application of the set of color harmony rules to the principal color.

5. The method of claim 3, wherein the step of identifying the set of interactivity colors further comprises:
identifying, by the computer system, a subset of the set of color harmony rules based on the principal color and the accent color, wherein the fixed relationships specified by the subset corresponds to a relationship between principal color and the accent color; and
identifying, by the computer system, the set of interactivity colors, wherein the set of interactivity colors are identified based on an application of the subset of the set of color harmony rules to the principal color and the accent color.

6. The method of claim 5, wherein the subset of the set of color harmony rules comprises a plurality of the set of color harmony rules, wherein the step of generating the set of color palettes further comprises:
generating, by the computer system, the set of color palettes from the principal color, the accent color, the set of interactivity colors identified based on the plurality of the set of color harmony rules, and the set of data visualization colors.

7-11. (canceled)

12. A computer system comprising:
a display system that displays a graphical user interface according to one of a set of color palettes; and
a palette generator in communication with the display system, wherein the palette generator: identifies a predominant color within an image, wherein the image is a logo for a corporation; identifies a principal color a for a graphical user interface to be displayed on the display system based on an application of a set of color harmony rules to the predominant color identified within the image; identifies a secondary color within the image; identifies and accent color for the graphical user interface based on an application of the set of color harmony rules to the secondary color identified within the image; receives a set of key-word descriptors for projected traits of the corporation; associates the set of key-word descriptors with a subset of a set of shading rules and a set of tinting rules; identifies a set of interactivity colors for presenting system activities in the graphical user interface, wherein the set of interactivity colors are identified based on an application of the subset of the set of shading rules and the set of tinting rules to at least one of the principal color and the accent color; identifies a set of data visualization colors for presenting data visualization in the graphical user interface, wherein the set of data visualization colors are identified based on an application of the subset of the set of shading rules and the set of tinting rules to at least one of the principal color, the accent color, and the set of interactivity colors; and generates the set of color palettes from the principal color, the accent color, the set of interactivity colors, and the set of data visualization colors.

13. The computer system of claim 12, wherein the set of color harmony rules specifies fixed relationships between two or more colors in a color wheel.

14. The computer system of claim 13, wherein the set of color harmony rules is selected from the group consisting of a complementary harmony, an analogous harmony, a triadic harmony, a split complementary harmony, a tetratic harmony, and a square harmony.

15. The computer system of claim 14, wherein identifying the accent color further comprises:
identifying the accent color for the graphical user interface on the display system based on an application of the set of color harmony rules to the principal color.

16. The computer system of claim 14, wherein identifying the set of interactivity colors further comprises:
identifying a subset of the set of color harmony rules based on the principal color and the accent color, wherein the fixed relationships specified by the subset corresponds to a relationship between principal color and the accent color; and
identifying the set of interactivity colors, wherein the set of interactivity colors are identified based on an application of the subset of the set of color harmony rules to the principal color and the accent color.

17. The computer system of claim 16, wherein the subset of the set of color harmony rules comprises a plurality of the set of color harmony rules, wherein generating the set of color palettes further comprises:
generating the set of color palettes from the principal color, the accent color, the set of interactivity colors identified based on the plurality of the set of color harmony rules, and the set of data visualization colors.

18-22. (canceled)

23. A computer program product for generating a set of color palettes for displaying a graphical user interface, the computer program product comprising:
a computer readable storage media;
program code, stored on the computer readable storage media, for identifying a predominant color within an image, wherein the image is a logo for a corporation;
program code, stored on the computer readable storage media, for identifying a principal color for a graphical user interface to be displayed on a display system based on an application of a set of color harmony rules to the predominant color identified within the image;
program code, stored on the computer readable storage media, for identifying a secondary color within the image;
program code, stored on the computer readable storage media, for identifying an accent color for the graphical user interface based on an application of the set of color harmony rules to the secondary color identified within the image;
program code, stored on the computer readable storage media, for receiving a set of key-word descriptors for projected traits of the corporation;
program code, stored on the computer readable storage media, for associating the set of key-word descriptors with a subset of a set of shading rules and a set of tinting rules;
program code, stored on the computer readable storage media, for identifying a set of interactivity colors for presenting system activities in the graphical user interface, wherein the set of interactivity colors are identified based on an application of the subset of the set of shading rules and the set of tinting rules to at least one of the principal color and the accent color;
program code, stored on the computer readable storage media, for identifying a set of data visualization colors for presenting data visualization in the graphical user interface, wherein the set of data visualization colors are identified based on an application of the subset of the set of shading rules and the set of tinting rules to at least one of the principal color, the accent color, and the set of interactivity colors; and
program code, stored on the computer readable storage media, for generating a set of color palettes from the principal color, the accent color, the set of interactivity colors, and the set of data visualization colors.

24. The computer program product of claim 23, wherein the set of color harmony rules specifies fixed relationships between two or more colors in a color wheel.

25. The computer program product of claim 24, wherein the set of color harmony rules is selected from the group consisting of a complementary harmony, an analogous harmony, a triadic harmony, a split complementary harmony, a tetratic harmony, and a square harmony.

26. The computer program product of claim 25, wherein the program code for identifying the accent color further comprises:
program code, stored on the computer readable storage media, for identifying the accent color for the graphical user interface on the display system based on an application of the set of color harmony rules to the principal color.

27. The computer program product of claim 25, wherein the program code for identifying the set of interactivity colors further comprises:
program code, stored on the computer readable storage media, for identifying a subset of the set of color harmony rules based on the principal color and the accent color, wherein the fixed relationships specified by the subset corresponds to a relationship between principal color and the accent color; and
program code, stored on the computer readable storage media, for identifying the set of interactivity colors, wherein the set of interactivity colors are identified based on an application of the subset of the set of color harmony rules to the principal color and the accent color.

28. The computer program product of claim 27, wherein the subset of the set of color harmony rules comprises a plurality of the set of color harmony rules, wherein the program code for generating the set of color palettes further comprises:
program code, stored on the computer readable storage media, for generating the set of color palettes from the principal color, the accent color, the set of interactivity colors identified based on the plurality of the set of color harmony rules, and the set of data visualization colors.

29-33. (canceled)
